(19) United States
(12) Patent Application Publication
(10) Pub. No.: US 2024/0062138 A1
(43) Pub. Date: Feb. 22, 2024

(54) IDENTIFYING AND PRESENTING INFORMATION ABOUT FOOD SAFETY IN AN ORDER FULFILLMENT SYSTEM

(71) Applicant: Target Brands, Inc., Minneapolis, MN (US)

(72) Inventors: Theodore Nelson, Minneapolis, MN (US); Slade Baumann, Minneapolis, MN (US); Jathin Jayan, Minneapolis, MN (US); Syed G. H. Mohammed, Minneapolis, MN (US); Andria Rambow, Minneapolis, MN (US)

(21) Appl. No.: 18/235,580

(22) Filed: Aug. 18, 2023

Related U.S. Application Data
(60) Provisional application No. 63/399,469, filed on Aug. 19, 2022.

(51) Int. Cl. G06Q 10/0832; G06Q 10/0833; G06F 3/04817; G06Q 50/30; G06Q 30/0601

(52) U.S. Cl. CPC G06Q 10/0832; G06Q 10/0833; G06F 3/04817; G06Q 50/30; G06Q 30/0635

(57) ABSTRACT

The disclosed technology provides for managing and delivering orders having special items to customers at an order fulfillment location. A method can include receiving, at a user device in a group of user devices, information that causes the user device to display a first graphical user interface (GUI) including a list of orders for customers for fulfillment at a fulfillment location, presenting, at the user device and for each order in the list, an amount of time that the order has been scanned out of a hold location and awaiting customer arrival, receiving, at the user device, instructions to update the first GUI based on a determination, for each order in the list, that the amount of time for the order exceeds a first threshold amount of time, and presenting, at the user device and based on the instructions, the order in the list in a first indicia.

### CROSS-REFERENCE TO RELATED APPLICATIONS

This application claims the benefit of U.S. Application Ser. No. 63/399,469, filed on Aug. 19, 2022. The disclosure of the prior application is considered part of (and is incorporated by reference in) the disclosure of this application.

### TECHNICAL FIELD

This document generally relates to architecture of computer systems, communications between computing devices, and graphic user interfaces for eliciting user input.

### BACKGROUND

Computing devices are devices that accept data input, process the data, and provide data output using hardware and software. Computing devices can communicate with other computing devices using wired or wireless networks or a combination thereof. For example, computing devices can communicate over the Internet. User interactions with a computing device can cause the computing device to transmit communications to a second computing device, which can cause the second computing device to provide output such as changes to a visual display, sounds, or tactile output. Such output at the second computing device can elicit user input from a user of the second computing device, which can in turn cause the second computing device to transmit one or more communications to the first computing device thereby causing the first computing device to generate additional output.

### SUMMARY

This document generally describes a network based order fulfillment system that provides information to one or more user devices that allow users, such as employees, of the user devices located at a fulfillment location (such as a physical store location, a restaurant, a warehouse, or other location) to fulfill orders placed by users, such as customers, of other user devices. More particularly, the disclosed technology provides techniques for fulfilling drive up or pickup orders that include specially designated items. The disclosed technology can also be used to ensure that specially designated items that are considered perishables are stored at preferred temperatures and not left at room temperature for long periods of time to reduce or otherwise avoid spoilage.

Special item designations can include alcohol, perishable items, other grocery items, homeware, medication (prescription or non-prescription), and/or age-restricted items. A user interface presented at the user device of an employee can include one or more quick reference icons next to a particular order displayed in a list of multiple orders. The one or more quick reference icons can indicate items of a particular special designation that are included in the order. These quick reference icons can help to ensure that the employee performs specific actions or takes specific precautions with respect to the specially designated item(s). Such precautions can include waiting a predetermined amount of time before removing the specially designated item(s) from a staging area (such as when the specially designated item(s) is a perishable item that should remain refrigerated to avoid spoilage), checking a customer's identification (such as when the specially designated item(s) is an age-restricted item, like alcoholic beverages), and/or separating out age-restricted items from other items (e.g., some states do not allow alcohol to be delivered to a customer's car, so the customer would have to enter the fulfillment location to receive the part of their order that contains the alcohol).

Moreover, the disclosed technology provides for keeping track of amounts of time that perishable items have been removed from cold storage (e.g., either within a retail store or cold storage located in a staging area of the fulfillment location) and alerting employees of the fulfillment location when those perishable items have been out of cold storage for too long. An alert, for example, can indicate that the a perishable item has been out of cold storage for over a threshold period of time and a customer who ordered the perishable item is still a threshold amount of time away from the fulfillment location. Thus, the alert can prompt an employee to return the perishable item to the cold storage. In some implementations, and depending on a type of the perishable item and for how long the perishable item was out of cold storage, the alert can prompt the employee to discard the item and replace it with a new item from cold storage. Thus, two different time threshold can be used for returning the perishable item to cold storage versus discarding and replacing the perishable item.

One or more embodiments described herein can include a method including providing, by a computing system to each of a group of user devices, information that, when processed by each of the group of user devices, causes each of the group of user devices to display a first graphical user interface (GUI), the first GUI including a list of orders for customers for fulfillment at a fulfillment location; determining, by the computing system and for each order in the list of orders, an amount of time that the order has been scanned out of a hold location and awaiting customer arrival, determining, by the computing system and for each order in the list of orders, whether the amount of time exceeds a first threshold amount of time, and providing, by the computing system to at least a subset of the group of user devices and based on a determination that the amount of time for the order exceeds the first threshold amount of time, instructions to update the first GUI such that the order is represented in a first indicia.

In some implementations, the embodiments described herein can optionally include one or more of the following features. For example, the first indicia can be yellow highlighting. The first threshold amount of time can be 10 minutes. The method can also include determining, by the computing system and for each order in the list of orders, whether the order has been returned to the hold location within a second threshold amount of time from being scanned out of the hold location, and providing, by the computing system to at least a subset of the group of user devices and based on a determination that the order has not been returned within the second threshold amount of time, instructions to update the first GUI such that the order is represented in a second indicia, the second indicia being different from the first indicia. The second indicia can be red highlighting. The second threshold amount of time can be 15 minutes.

In some implementations, the method can also include providing, by the computing system to each of the group of user devices, information that, when processed by each of the group of user devices, causes each of the group of user devices to display at least one graphical icon with each order in the list of orders in the first GUI display, the at least one graphical icon providing a visual indication of a type of item associated with the order. The at least one graphical icon can include a visual depiction of one or more alcoholic beverages. The at least one graphical icon can include a visual depiction of produce. The at least one graphical icon can include a visual depiction of a dairy product. The at least one graphical icon can include a visual depiction of a meat product. The at least one graphical icon can include a visual depiction of an electronic device. The at least one graphical icon can include a visual depiction of a pharmaceutical product.

As another example, the method can also include receiving, by the computing system and from a first user device of the group of user devices, an indication of user selection of a first control presented in the first GUI indicating an intention to deliver an order in the list of orders, providing, by the computing system at the first user device, information that, when processed by the first user device, causes the first user device to display a second GUI, the second GUI including indications of one or more order hold locations in the fulfillment location and one or more bags associated with each of the one or more order hold locations for the selected order to be delivered, receiving, by the computing system and from the first user device, an indication of user selection of an indication of a bag presented in the second GUI indicating an intention to put the bag back in the respective hold location, providing, by the computing system to the first user device, information that, when processed by the first device, causes the first device to display a pop out window that overlays a portion of the second GUI, the pop out window including information about items in the selected bag, receiving, by the computing system and from the first user device, an indication of user selection of an option presented in the pop out window to put the selected bag back in the respective hold location, and providing, by the computing system to the first user device, information that, when processed by the first device, causes the first device to update the indication of the selected bag. Updating the indication of the selected bag can include changing the indication of the selected bag from a black bag icon to a green bag icon. Updating the indication of the selected bag can include removing a hazard symbol overlaying a portion of the indication of the selected bag.

In some implementations, the method can also include receiving, by the computing system and from the first user device, an indication of user deselection of an icon for a portion of the selected order to be delivered in the second GUI indicating an intention to deliver the selected order without the portion of the order and providing, by the computing system and to at least a subset of the group of user devices, information that, when processed by each user device of the at least subset of the group of user devices, causes the user device to present the portion of the selected order in a list of orders to be prepared in the first GUI. The method can also include receiving, by the computing system and from the first user device, an indication that the selected order was delivered to a respective customer without the portion of the order, and providing, by the computing system and to the at least subset of the group of user devices, information that, when processed by each user device of the at least subset of the group of user devices, causes the user device to remove the delivered order from the list of orders in the first GUI.

The method can also include receiving, by the computing system and from a second user device of the group of user devices, an indication of user selection of a second control presented in the first GUI indicating an intention to prepare the portion of the order in the list of orders to be prepared, providing, by the computing system at the second user device, information that, when processed by the second user device, causes the second user device to display the second GUI, the second GUI including indications of one or more order hold locations in the fulfillment location and one or more bags associated with each of the one or more order hold locations for the selected portion of the order to be prepared, receiving, by the computing system from the second user device, an indication that the one or more bags for the portion of the order have been scanned out of the one or more hold locations, receiving, by the computing system from the second user device, an indication that the portion of the order was delivered to a respective customer, and providing, by the computing system and to the at least subset of the group of user devices, information that, when processed by each user device of the at least subset of the group of user devices, causes the user device to remove the portion of the order from the list of orders to be prepared in the first GUI. The second user device can be the same as the first user device. The second user device can be different than the first user device.

In some implementations, receiving, by the computing system from the second user device, an indication that the portion of the order was delivered to a respective customer can include receiving an indication that customer information was verified, by the second user device, before delivering the portion of the order. The customer information can include at least one of a birthdate, a government ID, a drivers license, a passport, a medical prescription, and a pharmaceutical prescription. Verifying the customer information, by the second user device, can include determining that the customer information satisfies threshold requirements for delivering the portion of the order to the respective customer, the threshold requirements including at least one of (i) a minimum age for alcoholic consumption, (ii) a minimum age for alcoholic purchase, and (iii) a valid medical or pharmaceutical prescription. In some implementations, the portion of the order can include at least one alcoholic beverage. The portion of the order can include at least one medication.

As another example, determining, by the computing system and for each order in the list of orders, whether the amount of time exceeds a first threshold amount of time can include determining whether the order contains at least one item having (i) a refrigerated hold location or (ii) a frozen hold location. The method can also include providing, by the computing system to the at least subset of the group of user devices, the instructions to update the first GUI further based on a determination that the order contains the at least one item having the refrigerated hold location or the frozen hold location. The first threshold amount of time can be longer for items having the refrigerated hold location than items having the frozen hold location. The first threshold amount of time can also be longer for items having the frozen hold location than items having the refrigerated hold location.

In some implementations, the first threshold amount of time can be longer for the order than other orders in the list of orders based on a determination, by the computing system, that the order contains at least one item that is part of a first threshold category. The first threshold category can be a produce category. The first threshold category can be a perishable goods category.

The first threshold amount of time can be shorter for the order than other orders in the list of orders based on a determination, by the computing system, that the order contains at least one item that is part of a second threshold category. The second threshold category can be a frozen goods category. The second threshold category can be a refrigerated goods category. The second threshold category can be a fresh produce category. The second threshold category can be a meats category.

As another example, the method can also include determining, by the computing system and for each order in the list of orders, whether the order contains at least one item that is part of a third threshold category, and performing, by the computing system and based on a determination that the order contains at least one item that is part of the third threshold category, the method described above. The third threshold category can be at least one of refrigerated products, frozen products, produce, dairy products, and meats.

One or more embodiments described herein can also include a method for managing and delivering orders having special items to customers at an order fulfillment location, the method including: receiving, from a computing system and at a user device in a group of user devices, information that, when processed by the user device, causes the user device to display a first graphical user interface (GUI) including a list of orders for customers for fulfillment at a fulfillment location, presenting, at the user device and for each order in the list of orders, an amount of time that the order has been scanned out of a hold location and awaiting customer arrival, receiving, from the computing system and at the user device, instructions to update the first GUI based on a determination, by the computing system and for each order in the list of orders, that the amount of time for the order exceeds a first threshold amount of time, and presenting, at the user device and based on the instructions from the computing system, the order in the list of orders in a first indicia.

The method can optionally include one or more of the following features. For example, the first indicia can be a yellow highlighting. The order can include at least one special item, the special item being at least one of a refrigerated item and a frozen item. The method can also include receiving, at the user device, an indication of user selection of a first control presented in the first GUI indicating an intention to deliver an order in the list of orders, receiving, from the computing system at the user device, information that, when processed by the user device, causes the user device to display a second GUI including indications of one or more order hold locations in the fulfillment location and one or more bags associated with each of the one or more order hold locations for the selected order to be delivered, receiving, at the user device, an indication of user selection of an indication of a bag presented in the second GUI indicating an intention to put the bag back in the respective hold location, the bag including at least one special item, receiving, from the computing system at the user device, information that, when processed by the user device, causes the user device to display a pop out window that overlays a portion of the second GUI, the pop out window including information about items in the selected bag, receiving, at the user device, an indication of user selection of an option presented in the pop out window to put the selected bag back in the respective hold location, and receiving, from the computing system at the user device, information that, when processed by the user device, causes the user device to update the indication of the selected bag.

As another example, the at least one special item can be at least one of a grocery item, a refrigerated item, a frozen item, an adult beverage, a tobacco product, and a medication. The intention to put the bag back in the respective hold location can be based at least in part on the order being presented in the first GUI in the first indicia. The intention to put the bag back in the respective hold location can be based at least in part on the bag containing an age-restricted item. The age-restricted item can be at least one of an adult beverage, a tobacco product, and a medication.

In some implementations, the method can also include receiving, at the user device, an indication of user deselection of an icon for a portion of the selected order to be delivered in the second GUI indicating an intention to deliver the selected order without the portion of the order, and receiving, from the computing system at the user device, information that, when processed by the user device, causes the user device to present the portion of the selected order in a list of orders to be prepared in the first GUI. The intention to deliver the selected order without the portion of the order can be based at least in part on the portion of the order containing an age-restricted item. The method can also include receiving, at the user device, an indication of user selection of an option to complete delivery of the portion of the order and presenting, at the user device, a third GUI including a field for verifying a customer associated with the order. The field can include selectable options to input an age of the customer. The field can also include an option to scan a drivers license or government-issued ID of the customer. In some implementations, the method can include receiving, at the user device, user input in the field to verify the customer and verifying, at the user device, the customer based on the user input satisfying local requirements associated with an item in the portion of the order. The item in the portion of the order can be an adult beverage and the local requirements can indicate that the customer must be at least 21 years old to pick up the item in the portion of the order.

One or more embodiments described herein can include a system having: one or more processors and computer memory containing instructions that, when executed by the one or more processors, cause the system to perform operations including: providing, to each of a group of user devices, information that, when processed by each of the group of user devices, causes each of the group of user devices to display a first graphical user interface (GUI), the first GUI including a list of orders for customers for fulfillment at a fulfillment location, determining, for each order in the list of orders, an amount of time that the order has been scanned out of a hold location and awaiting customer arrival, determining, for each order in the list of orders, whether the amount of time exceeds a first threshold amount of time, and providing, to at least a subset of the group of user devices and based on a determination that the amount of time for the order exceeds the first threshold amount of time, instructions to update the first GUI such that the order is represented in a first indicia.

The system can optionally include one or more of the abovementioned features.

The devices, system, and techniques described herein may provide one or more of the following advantages. For example, the disclosed techniques provide for ensuring specially designated items are appropriately and efficiently handled by an employee during drive up or pickup order fulfillment. The employee can quickly see a visual icon indicating the specially designated item(s) in a particular order to determine what action(s) may be required for the item(s) in order to complete order fulfillment. The employee, therefore, may not forget to perform actions including but not limited to checking a government ID for a customer who is picking up an order with alcoholic beverages, certain types of medications, tobacco products, or other age-restricted items. The order fulfillment process can therefore be performed accurately and efficiently without causing delays in the process.

As another example, the disclosed techniques can be performed to reduce or otherwise avoid food-based waste by tracking amounts of time that perishable items are left out of cold storage before being delivered to a customer. Sometimes, if the perishable items are out in room temperature for too long (e.g., longer than a first threshold amount of time, where the first threshold amount of time can also vary depending on the type of perishable items), the perishable items may go bad and thus require the employee to discard and replace them before the customer arrives to pick up their order. The disclosed techniques can be used to prevent the perishable items from going bad and having to be discarded by notifying the employee when the perishable items have been out of cold storage for too long and should be returned to cold storage. The disclosed technology can also provide for determining when the perishable items should be discarded and replaced for having been left out in room temperature for too long (e.g., longer than a second threshold amount of time, which can be longer than the first threshold amount of time and/or based on the type of perishable items). With the disclosed techniques, fresh food items can be delivered to the customer, thereby improving overall customer experience and satisfaction with the order fulfillment process, ensuring quality of items provided by the fulfillment location for drive up and pickup orders, and reducing food item-based waste.

The disclosed techniques also provide for dynamically updating information presented at user devices of the employees in the fulfillment location such that the employees can be aware of the status of specially designated items associated with different orders. Information can be updated at the user devices in real or near real time, so that order fulfillment activities can be efficiently completed by the employees (such as returning perishable items to cold storage before they spoil and checking a customer's government ID before delivering age-restricted items in their order). This can increase efficiency in order fulfillment so that customers may arrive at the fulfillment location and not wait for extended periods of time while their orders are being prepared, staged, and/or delivered. An overall customer experience may be improved.

The disclosed techniques also provide intuitive and user friendly controls, visual indications, and graphical elements to facilitate efficient fulfillment of tasks in drive up or pickup orders. Various GUIs can be automatically updated to ensure the most important information is visually communicated to the employee in an efficient manner. As a result, the employee can quickly and efficiently address potential issues, such as putting perishable items back in cold storage, without compromising the customer experience and/or greatly reducing efficiency of order fulfillment activities. The improved GUIs and automatic updating of the GUIs in response to outside information (including communications between computing devices and/or prolonged estimated times of arrival for customers) can increase information comprehension of users, thereby improving efficiency of the system.

As another example, by providing streamlined communications between mobile user devices operated by customers and the employees working at fulfillment locations, an order fulfillment system can reduce the amount of time spent interacting with the mobile devices, thereby reducing power consumption and improving battery life of the computing devices. Additionally, by streamlining communications while providing for computer network based ordering and pickup facilitation, the computing system can reduce the amount of communications to and from mobile user devices, thereby reducing bandwidth usage of one or more communications networks and freeing up communications bandwidth for other purposes. Additionally, unique user interface elements at the user devices can improve user experience thereby leading to improved outcomes with respect to efficiency and accuracy of both user interactions with the user devices and fulfillment of orders.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is diagram of an example system for facilitating drive-up order fulfillment.

FIGS. 2A-Y show example user interface displays for computing devices in a drive-up order fulfillment system.

FIGS. 3A-D show example user interface displays for ensuring food safety of perishable items in a drive-up order fulfillment system.

FIGS. 4A-I show example user interface displays for preparing and delivering partial orders.

FIG. 5 is a flowchart of a process to be performed by one or more computing devices in a drive-up fulfillment system when an order for a drive-up customer includes perishable items.

FIG. 6 is a flowchart of another process to be performed by one or more computing devices in a drive-up fulfillment system when an order for a drive-up customer includes perishable items.

FIG. 7 is a flowchart of a process to be performed by one or more computing devices in a drive-up fulfillment system when an employee puts a portion of an order for a drive-up customer back in a hold location.

FIGS. 8A-B is a flowchart of a process to be performed by one or more computing devices in a drive-up fulfillment system when an employee completes a partial order for a drive-up customer.

FIG. 9 is a schematic diagram that shows an example of a computing device and a mobile computing device.

Like reference symbols in the various drawings indicate like elements.

### DETAILED DESCRIPTION OF ILLUSTRATIVE EMBODIMENTS

This document generally relates to systems, methods, and techniques for presenting information about specially designated items and food safety for items in drive-up and/or pick up orders at a fulfillment location (e.g., retail environments such as physical stores, warehouses, storage facilities, etc.). The disclosed technology can be used to accurately and efficiently fulfill such orders at the fulfillment location. For example, each employee of the fulfillment location can view a list of orders to be fulfilled in GUIs presented at their user devices. Each order in the list can include quick reference icons that indicate a general nature of items in the order. The quick reference icons, for example, can be graphical indications of alcoholic items, pharmaceutical items, fresh produce, dairy products, meat, fish, house products, clothing items, prepared hot items, hot beverages, and other items that may be sold or available for fulfillment by the fulfillment location. These icons can be used by the employees to quickly determine whether the order contains special items and therefore needs to be handled and/or fulfilled in a particular manner. For example, an order having an icon representing alcoholic beverages can indicate to an employee that the employee must check the corresponding customer's government ID for age verification before delivering the alcoholic beverages and thus completing the customer's order. Similarly, an order having the icon representing alcoholic beverages may require the employee to deliver part of the order to the customer and then complete the rest of the order, such as the portion of the order containing the alcoholic beverages, at another time (e.g., in some states, customers may be required to enter the fulfillment location to pick up alcoholic beverages because the alcoholic beverages may not be delivered to the customers' vehicles). As another example, an order having an icon representing dairy products can indicate to the employee that a portion of the order containing the dairy products should remain in cold storage until a predetermined amount of time before the corresponding customer arrives to avoid spoilage of the dairy products. One or more other actions can be taken in response to the different types of quick reference icons that are presented with each order in the list.

Moreover, the disclosed technology can be used by the employees to ensure that perishable items remain fresh to avoid spoilage or food-based waste. For orders having frozen, cold storage, or other perishable items, the disclosed technology can provide for tracking of how long the orders are kept out of cold storage in room temperature. The disclosed technology can alert the employee(s) in the fulfillment location when perishable items have been out of cold storage for too much time and thus should be returned to cold storage while the corresponding customer is not yet at the fulfillment location without any one employee being required to keep track of the amount of time that particular items have been out of cold storage. The disclosed technology can also alert the employee(s) when the perishable items have been in room temperature for longer than some threshold period of time and thus should be discarded and replaced with new items from cold storage before being delivered to the customer.

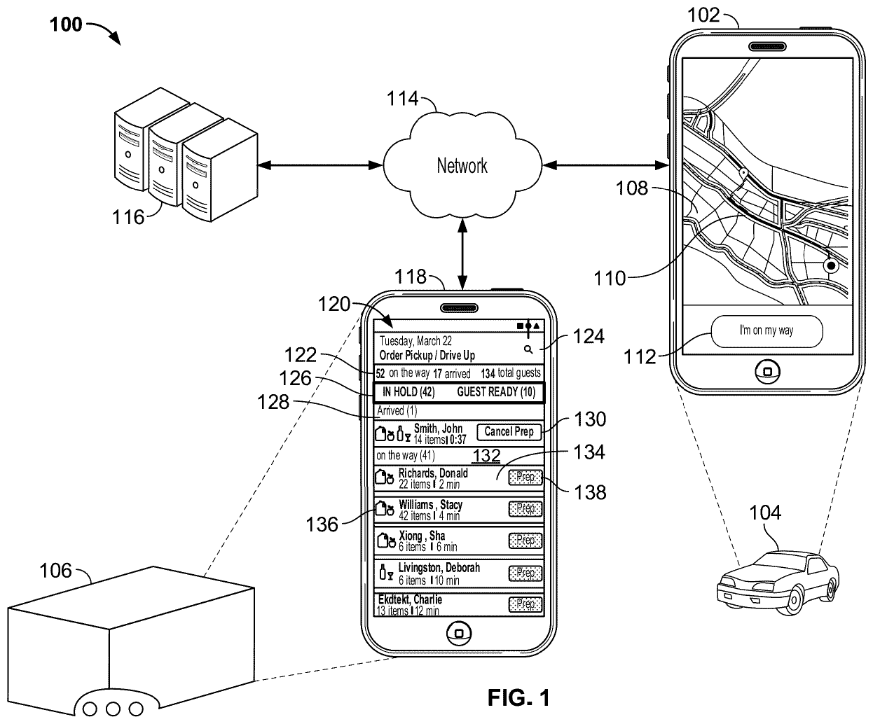

Referring to the figures, FIG. 1 is a diagram of an example system 100 for facilitating order fulfillment for drive-up pickup by customers. In the system 100, a customer who wishes to complete an online order for items by picking up the items using a drive-up service can access a dedicated application executing on a mobile device 102. The mobile device 102 can be, for example, a mobile phone, a tablet device, a touch screen computer, a laptop computer, a PDA, a smart watch, or other mobile device. In some implementations, instead of accessing a dedicated application executing on the mobile device 102, the customer can use a browser of the mobile device 102 to access a website that provides the below described functionality. Therefore descriptions related to use of the dedicated application apply equally to a web-based implementation.

The customer can use the dedicated application to select items for purchase from a store or other fulfillment location using an online shopping interface. For example, the dedicated application can be a grocery shopping application that can permit the customer to search and/or browse for grocery items, add desired items to a virtual shopping cart, and place an order for the selected items by entering payment information. The customer can also use the dedicated application to access one or more previously entered orders. For example, a user may have previously logged into an online account for a retailer associated with the dedicated application and placed an on-line order for one or more items using either the mobile device 102 or a different computing device such as a home or laptop computer. As another example, the customer may have previously placed an on-line order using the dedicated application. The customer can access and review the previously placed orders after logging into the dedicated application. This can include reviewing items included in the orders, estimated time until the order is ready, payment used for the order (e.g., “card ending in 123”), a fulfillment location for the order, and other information associated with the orders.

The mobile device 102 can communicate with other computing devices through a network 114, such as, for example, the Internet. For example, the mobile device 102 can communicate with a network access point such as a WiFi router or a cellular communication tower to access the network 114 and communicate with other computing devices. For example, the mobile device 102 can communicate with a server system 116 consisting of one or more servers to place the order. Alternatively, or additionally, the customer can use a different computer to place the order and the different computer can communicate through the network 114 with the server system 116. The server system 116 can be affiliated with a retailer and process the on-line order received from the mobile device 102 or another computing device. The server system 116 can facilitate fulfillment of the order by providing details of the order, such as ordered items, identity of the customer, an order number, time that the order was placed, etc. to one or more computing devices located at a fulfillment center such as a store 106. For example, the store 106 can be part of a chain of affiliated stores associated with a retailer and the server system 116 can be a server system associated with the retailer. Upon receiving an on-line order from the customer, the server system 116 can identify the store 106 as an appropriate fulfillment location for the order based on information such as, an indication of a preferred location for fulfillment indicated by the customer at the mobile device 102 or another computing device, a current location of the mobile device 102, another location associated with the customer (e.g., home or work address information entered by the user into a customer profile), based on item availability (e.g., by identifying a store where all or a majority of the items in the order are in stock), or based on a combination of these and one or more other factors.

For example, the server system 116 can identify the store 106 as an appropriate location for fulfilling the customer's order. The server system 116 can transmit information on the order to a computing device 118 in the possession of, or being used by, a user such as an employee of the store 106. The computing device 118 can be a mobile computing device, such as, for example, a mobile phone, a tablet device, a touch screen computer, a laptop computer, a PDA, a smart watch, or other mobile device. In some implementations, the computing device 118 can be a non-mobile or semi-mobile device such as a server, a desktop computer, a cash register, a smart TV, or other computing device. The server system 116 can provide appropriate information for the order to the computing device 118 such as items in the order, identifying information for the customer who placed the order, time the order was placed, a desired pickup time for the order (e.g., as indicated by the customer at the time of placing the order), an order number, and other relevant information.

At the time of placing the order, or at a different time, such as when logging into the dedicated application, the customer of the mobile device 102 can indicate a desired order fulfillment method for the order. For example, the customer can specify that the order is for drive-up fulfillment. A drive-up fulfillment allows the customer to drive to a fulfillment location, such as a retail store location, a warehouse, or another location where an employee of the retailer can meet the customer at the customer's vehicle 104, verify that the customer is receiving the proper order, and provide the items to the customer without the customer being required to exit their vehicle. For example, the customer can travel to the store 106, park in a designated area of the parking lot of the store 106, notify an employee that they have arrived using the dedicated application, and then receive the purchased items from the employee when the employee brings the items to the customer's vehicle 104.

As another example, the customer can specify that the order is for in-store pickup fulfillment. In-store pickup fulfillment can allow the customer to travel to a fulfillment location, such as the store 106, and enter the store to pick up the purchased items from a designated location within the fulfillment location. Such a fulfillment method can allow the customer greater flexibility by allowing the customer to shop for additional items within the store 106 (e.g., items that the customer wishes to see in-person before purchasing, such as clothing or produce) and then pick up the items from the on-line order at the designated location after completing their in-store shopping. Alternatively, the customer can pick up the order items without also shopping for items at the store 106 in person.

As another example, the customer can specify that the order is for delivery. An employee of the retailer or a third-party service can travel to the customer's home or another drop-off location designated by the customer to deliver the items in the order to the customer.

In the case of both drive-up and in-store pickup type order fulfillments, the customer can begin to travel to the fulfillment location, such as by driving the vehicle 104 to the store 106. In some implementations, information collected or generated by the mobile device 102 can be used to determine that the customer has begun to travel to the order fulfillment location. For example, location information determined by the mobile device 102, as described above, can be used to determine that the mobile device 102 has begun to travel along the route 110. For example, the dedicated application can receive location information for the mobile device 102 over sequential periods of time (e.g., every 2 seconds) and compare the movement of the mobile device 102 based on the changing location information to the route 110 to determine that the customer has begun to travel the route 110. Alternatively or additionally, the customer can select a user interface control 112 provided by the dedicated application to indicate that they have begun traveling toward the store 106. For example, the customer may have selected a permissions setting to not allow the dedicated application to access location information for the mobile device 102. In some implementations, the dedicated application will only display the user interface control 112 in situations in which the customer has not permitted the dedicated application to access location information for the mobile device 102. As another example, the mobile device 102 may be unable to accurately determine its location, for example, due to tall buildings interfering with GPS signals or due to lack of wireless communications access points in the area around the mobile device 102. The dedicated application can provide the user interface control 112 when the mobile device 102 is unable to accurately determine the location of the mobile device 102 so that the customer can indicate that they have begun to travel toward the store 106.

Upon determining that the customer has begun to travel toward the store 106 (e.g., based on location information collected by the mobile device 102 or based on user interaction with the user interface control 112), the mobile device 102 can communicate with one or more computing devices located at and affiliated with the store 106, either directly through the network 114 or by communicating with the server system 116 which in turn communicates appropriate information and instructions to the one or more computing devices located at the store 106. For example, an employee of the store 106 can use the computing device 118, which can receive information relevant to the order from the server system 116. The mobile device 102 can communicate with the server system 116 over the network 114 to indicate to the server system 116 that the customer has begun to travel toward the store 106. The server system 116 can then provide a communication to the computing device 118 of the employee to update information presented at the computing device 118 indicating that the customer of the mobile device 102 is on the way (and thus, that the order for the customer should be prepared and ready for the customer's arrival). The server system 118 may communicate directly with the computing device 118 through the network 114 or may communicate with a computing device/system located at the store 106 which then communicates with the computing device 118, e.g., through a wireless or wired local area network (LAN). In some implementations, the server system 116 or a central computing device located at the store 106 can communicate with the computing device 118 and one or more other computing devices in possession of other employees of the store 106 to allow multiple employees to receive information on on-line orders placed by customers and coordinate efforts to fulfill such orders.

The server system 116 can provide additional information along with this notification or prior to sending the notification that the user is on the way. For example, the server system 116 can provide vehicle identification information to the computing device 118 to allow the employee to more easily identify the customer's vehicle 104 when the customer has arrived at the designating drive-up fulfillment location at the store 106. The server system 116 can also provide information on an estimated time of arrival and/or an estimated time until arrival for the customer. Such timing information can be used to determine ranking of orders to be prepared in a GUI presented at the computing device 118. Therefore, the employee can use the timing information to prioritize which orders to prepare.

The computing device 118 includes a user interface 120 (e.g., GUI). The user interface 120 can, for example, be a user interface for another dedicated application executing on the computing device 118 or another instance of the same dedicated application that is executing on the mobile device 102. The user interface 120 includes a panel 122 having icons for different stages of order fulfillment. The icons can represent “On the way” stage, an “Arrived” stage, and a “Total guests” stage. Each icon can also include a numeric indication of how many orders are at the respective stage. The employee can select any of the icons to view, in the user interface 120, orders at the respective stage. The employee can select the control 122 by, for example, using a touch screen interface of the computing device 118 or one or more other input devices of or in communication with the computing device 118. The panel 122 can be a pickup dashboard, which can provide a quick and easy to understand overview of what is happening with pickup activities at the store 106. The panel 122 can indicate how many customers have notified the store 106 that they are on their way, how many customers have confirmed that they are at the store 106, and a total number of customers who have at least one order in a hold location. Thus, the panel 122 can indicate total customer counts rather than total order counts. A customer, for example, may have multiple orders but may only be counted once in the panel 122.

The user interface 120 further includes a control 124 to allow the employee to search for orders. The employee can type, using one or more input devices of the computing device 118 and/or by tapping on a touchscreen of the computing device 118 to select keys on a keyboard presented in the user interface 120, order numbers, customer names, or other identifying information into the control 124. Results from the employee's search can populate the user interface 120 or be presented in another user interface at the computing device 118. In some implementations, a customer may not have their barcode available when they arrive for pickup. So, the customer can search by the customer's name, order number, or other information using the control 124. If, on the other hand, the customer has their barcode or other identifier on hand, the employee can scan the barcode from the user interface 120 to process their order for pick up.

The user interface 120 also includes a panel 126 with selectable options for tabs: “In hold” and “Guest ready.” The selectable options may also include a numeric indication of how many orders are associated with each tab. The employee can select either of these options to view, in the user interface 120, lists of orders associated with “In hold” or “Guest ready.” Orders may be classified and listed under “In hold” if they have not yet been prepared and/or are currently being prepared. Orders may be classified and listed under “Guest ready” if employees completed preparation of such orders and the orders are ready to be delivered to customers upon their arrival at the store 106. Moreover, all orders for customers who indicated they are on their way can fall under the “In hold” or “Guest ready” tabs. In some implementations, both the “In hold” and “Guest ready” tabs can present lists of customers who have arrived and customers who are on their way. This presentation of information can be beneficial to help the employees prioritize which orders to prepare.

In the example depicted in FIG. 1, the dedicated application for employees can default to presenting “In hold” information in the user interface 120. The employee can also select the option for “In hold” in the panel 126. As a result, a list of orders that are not yet ready to be delivered to customers are presented in the user interface 120. The orders are depicted in an “Arrived” panel 128 and an “On the way” panel 132 to help the employee prioritize preparation of the orders that are “In hold.”

As described throughout this disclosure, there can be three stages of order preparation. Orders that have come in but have not yet been prepared can be in a first stage of order preparation. Once a customer indicates that they are on their way, an employee can start to prepare the customer's order. Once the order is put together, the employee can leave bags associated with that order in one or more hold locations. At this point, the order can be given a status of “In hold” (and thus, the order can appear in either of the panels 128 and/or 132). Either when an estimated time of arrival for the customer hits a certain threshold (e.g., 5 minutes) or the customer has indicated that they have arrived, an employee can move the bags associated with the customer's order from the hold locations to a second holding location, which is for orders that are ready to go out to customers' vehicles. At this point, the status of the order can change from “In hold” to “Guest Ready.”

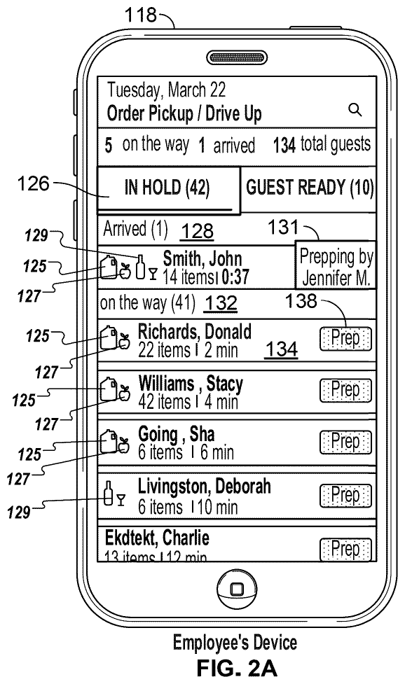

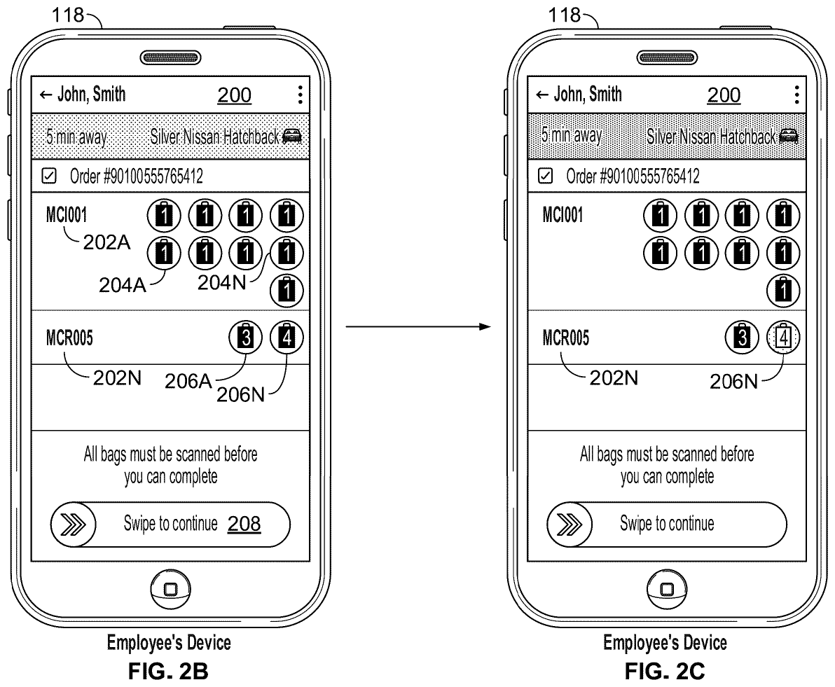

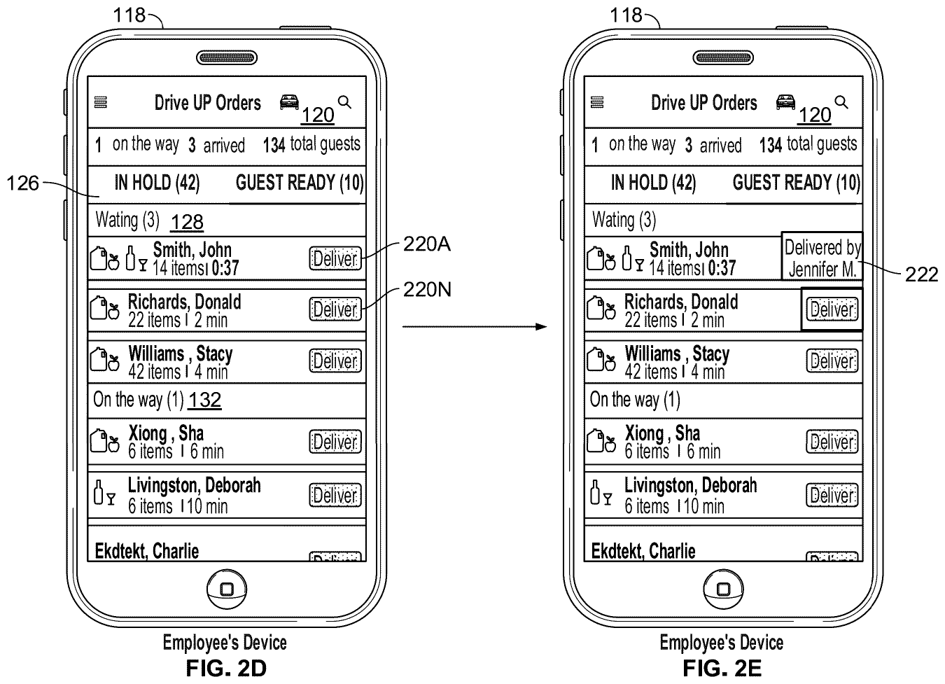

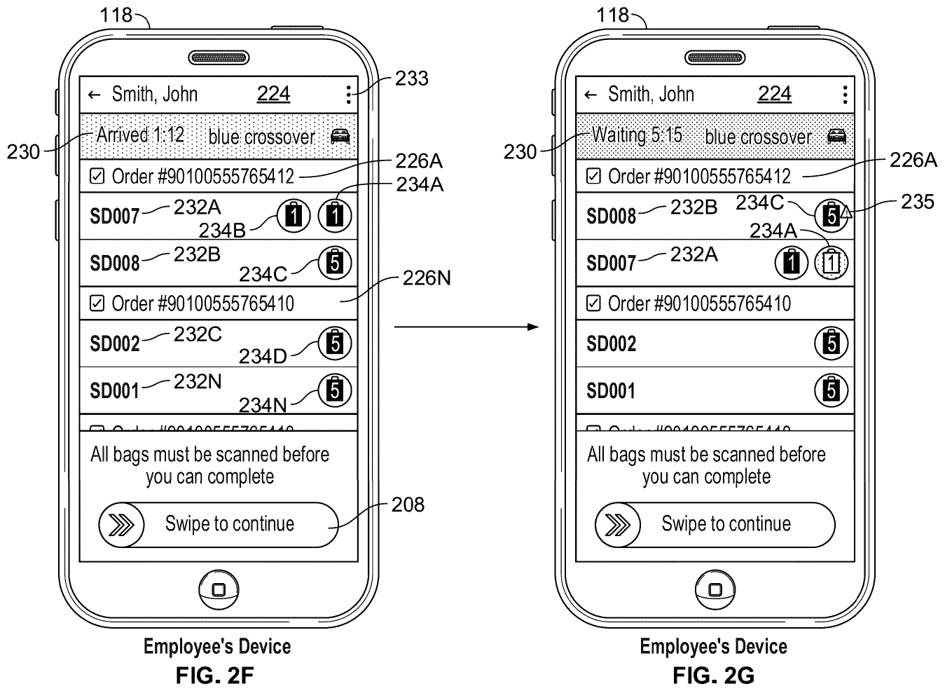

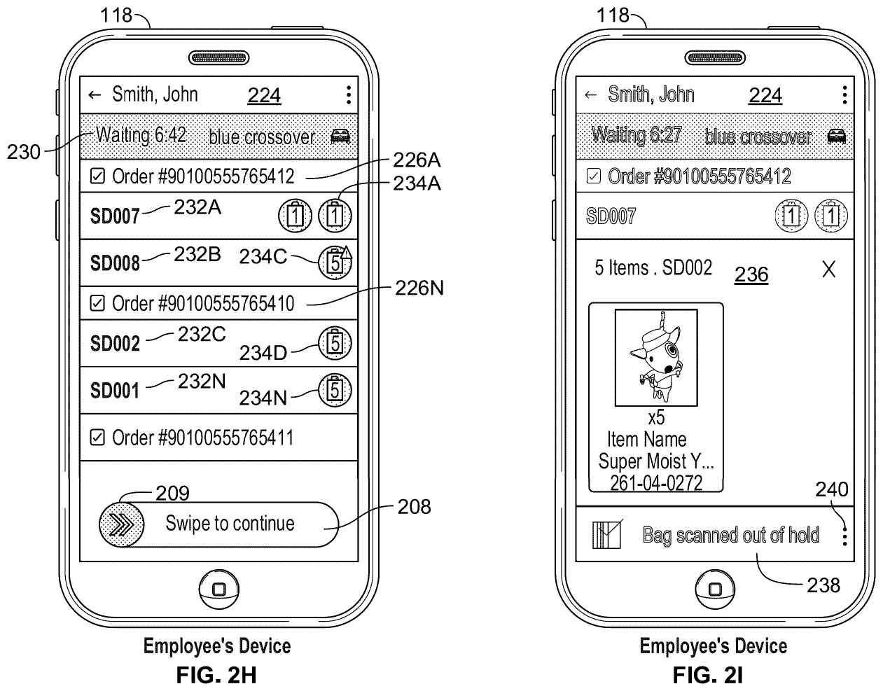

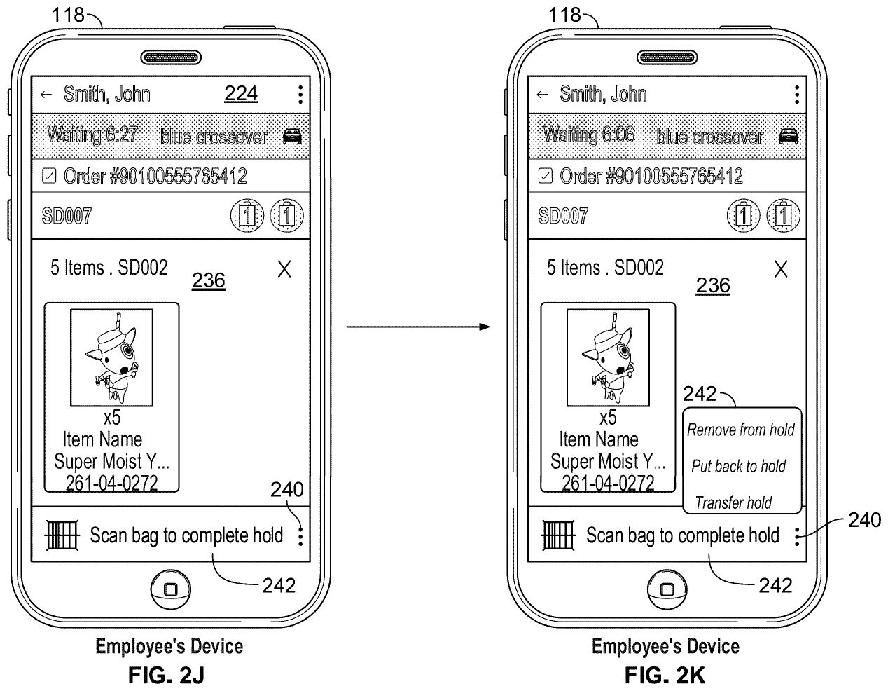

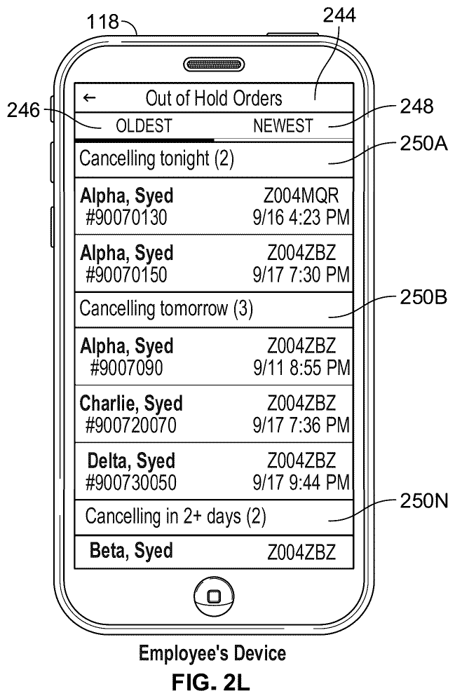

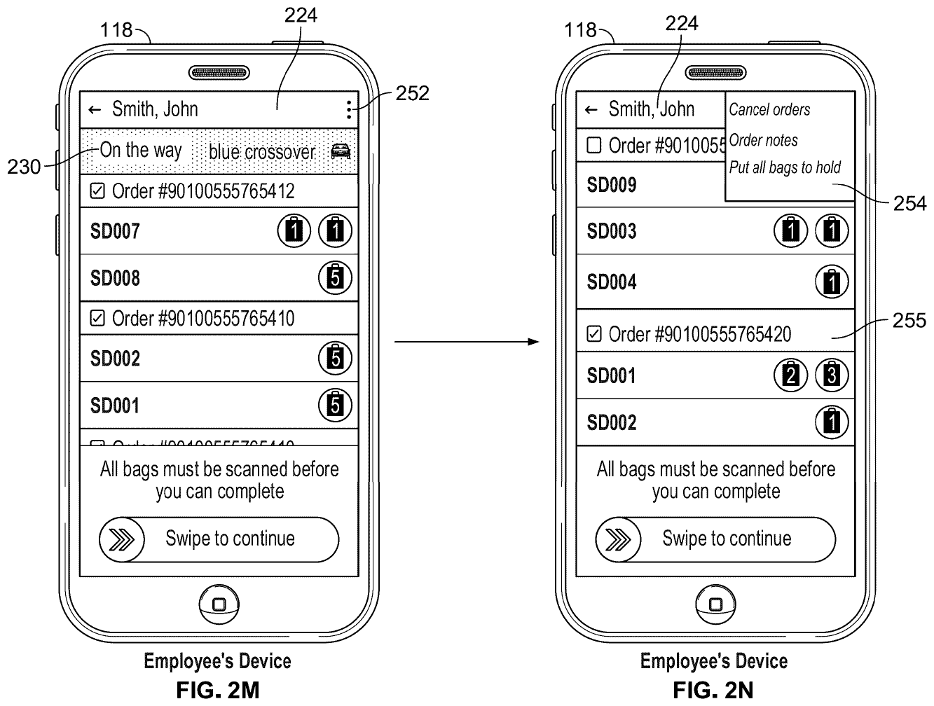

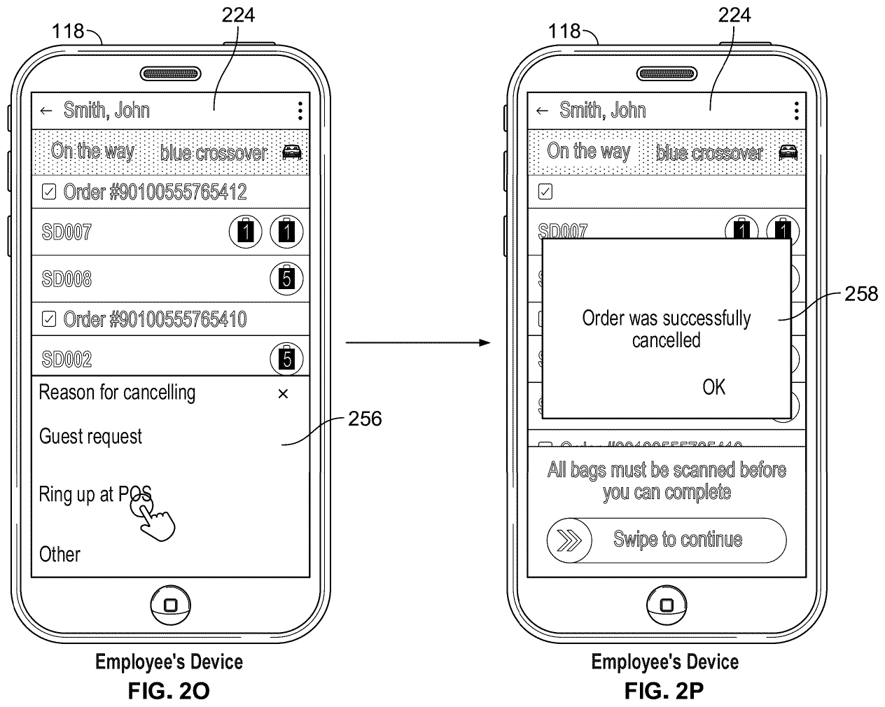

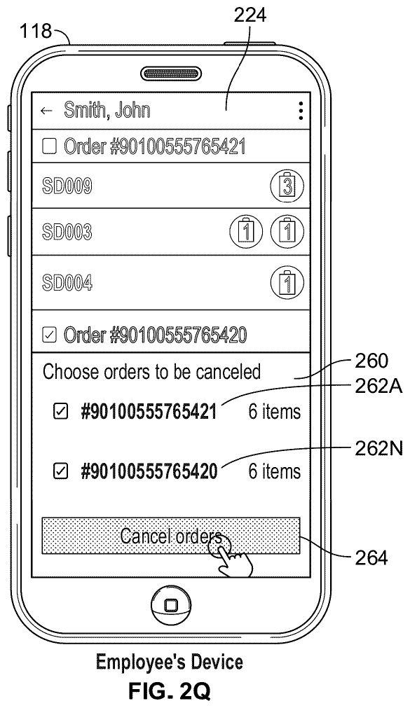

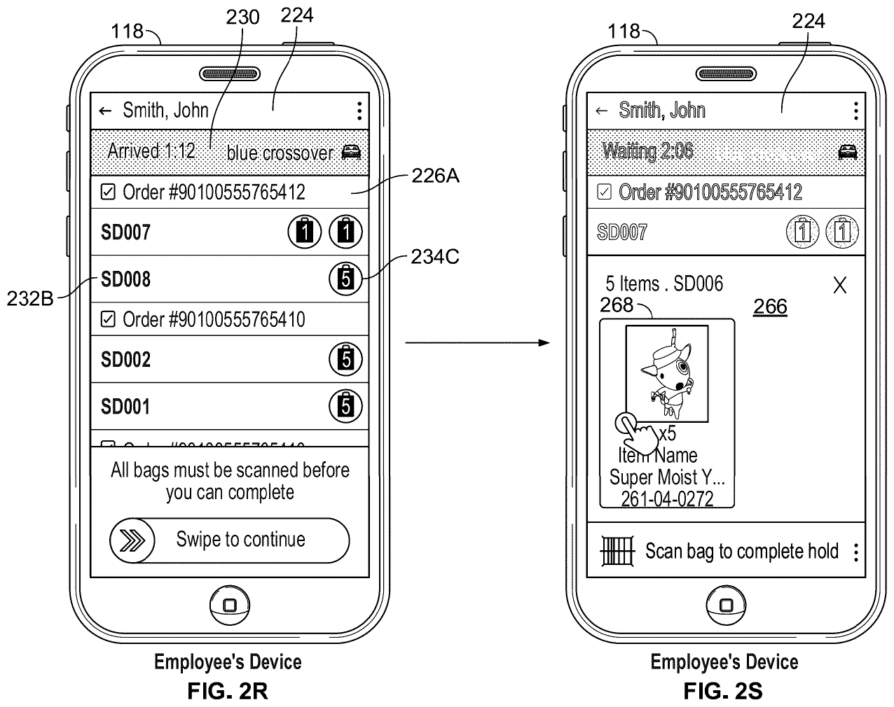

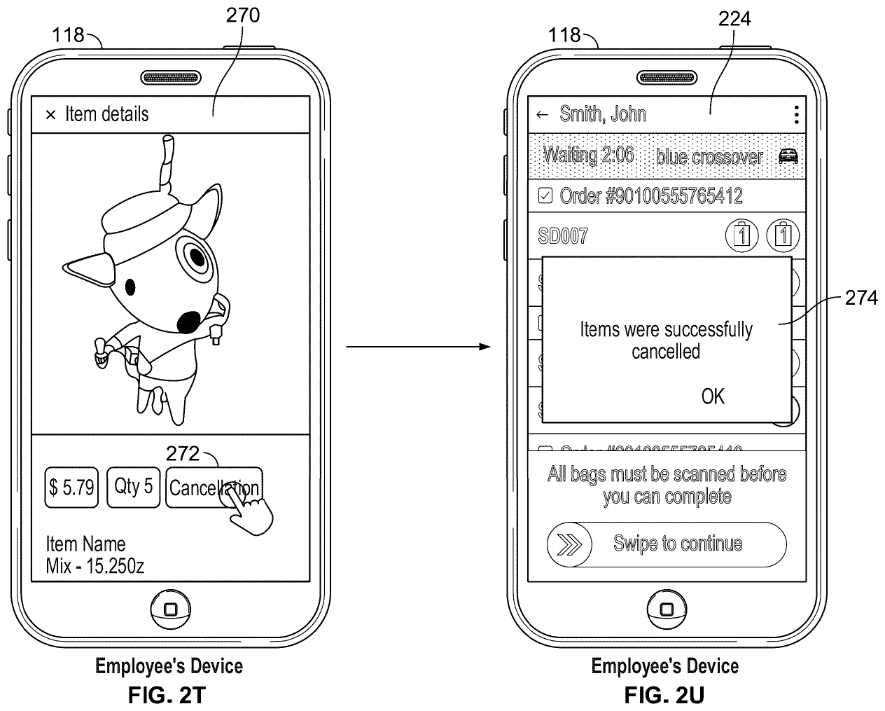

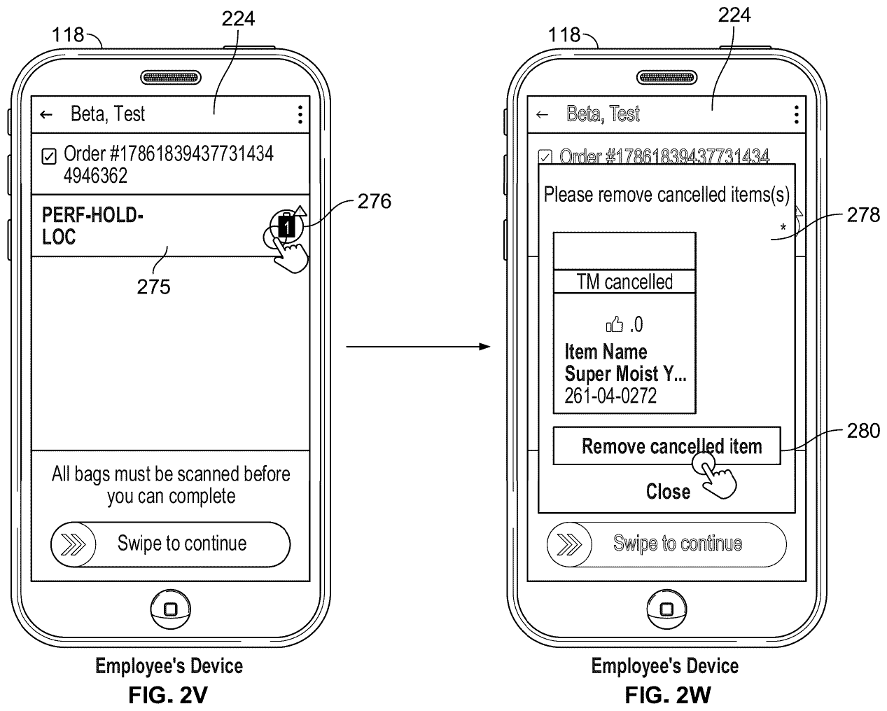

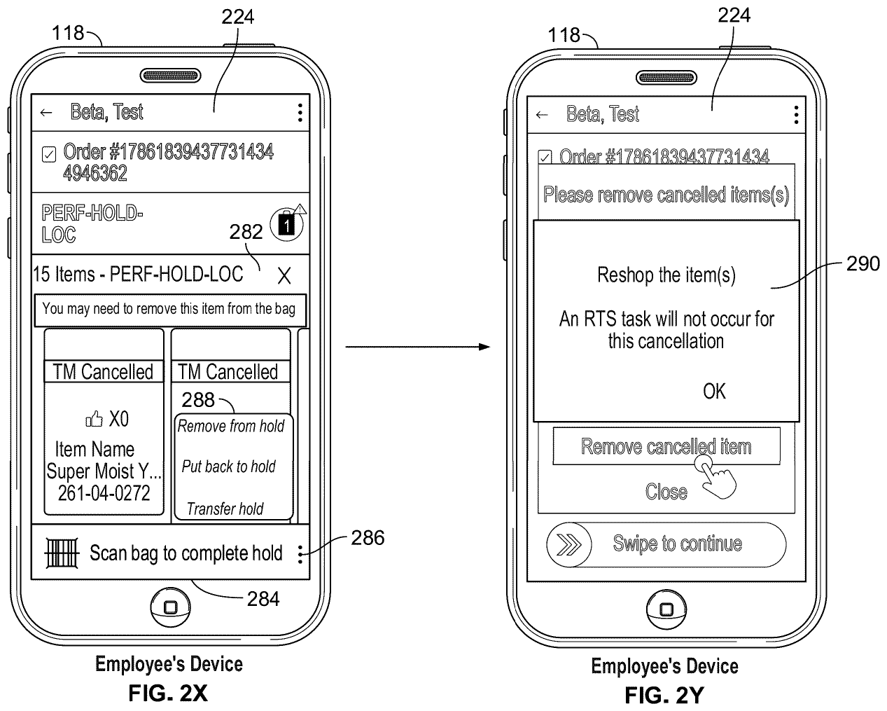

Controls can be presented in the panels 128 and 132 with each order. For example, an order in the panel 128 includes a control 130, which indicates “Cancel prep.” The employee can select the control 130 in order to cancel preparation of this order. In some implementations, the employee may cancel preparing the order at any time. Thus, the employee can cancel preparation (or delivery) of an order when they do not anticipate returning to the order (e.g., when the employee goes on a break, leaves for the day, etc.). Once the employee selects the control 130 and confirms that they are canceling preparing of the order, the control 130 can change to control 138 in each computing device 118 of employees in the store 106. Any employee can then claim a task of preparing the order. Any preparation scans that were made during a prior preparation process may not be recorded and whoever claims the task of preparing the order must scan every bag for the order. In some implementations, an employee can cancel another employee's claim of preparing an order in scenarios in which the another employee is no longer available (e.g., on break, left the building, etc.). To do so, the employee can click, tap, or otherwise select an order from the panel 128 or the panel 132, which can present another user interface at the computing device 118 (e.g., refer to FIG. 2B). In the another user interface, the employee can click, tap, or otherwise select a menu option (e.g., a three-dot menu located at the top right corner of the user interface 200 in FIG. 2B) and then an option within the menu to “cancel work.” By selecting this option, the user interface 120 can be updated as described above in reference to cancelling an order as it is currently being prepared.

Orders in the panel 132 also include control 138, which indicates “Prep.” The employee can select the control 138 next to any of the orders in the panel 132 in order to begin preparing that order while the customer is on the way. The employee can therefore claim the task of preparing an order by selecting the control 138 for that order. The employee can also claim the task of preparing more than one order by selecting the control 138 for each order the employee desires to prepare. Moreover, graphical elements 136 are presented with each order in the panels 128 and 132. The graphical elements 136 can indicate one or more types of items that are part of the respective order (e.g., grocery items, alcoholic beverages, etc.).

Each panel 128 and 132 can include order listings, such as order listing 134. Order listings in the panel 132 can be organized alphabetically by customer name since not every customer may share their location information. Order listings in the panel 128, on the other hand, can be organized by first in first out logic to help prioritize which orders should be worked on and completed first.

The order listing 134 is in the “On the way” panel 132. The order listing 134 has not yet been claimed by an employee to be prepared. Therefore, the order listing 134 is displayed with the control 138 to “Prep” the order. The order listing 134 includes customer information. A customer name listed in the order listing 134 can match a label placed on one or more bags for the respective order. The order listing 134 can also include an item count, indicating how many items are in the order. In some implementations, the order listing 134 may include a bag count. The order listing 134 can also include a number of minutes as an ETA based on information shared from the customer's device 102 as the customer is on their way to the store 106. Depending on the customer's application settings, the ETA may not be updated in real time. In some implementations, for example, no ETA may be shown in the order listing 134, which can indicate that the customer has chosen not to share their location information. When the customer arrives at the store 106, their order listing 134 can be moved from the “On the way” panel 132 to the “Arrived” panel 128. The ETA in the order listing 134 can then be changed to a timer indicating how much time has passed since the customer indicated that they arrived at the store 106.

In some implementations, order listings in the panels 128 and 132 are user selectable to allow the employee to view additional information about each order (as explained in greater detail below). Additional details that can be displayed at the computing device 118 in response to selection of an order can include an order number, a list of bags to scan out of hold locations and/or a number of bags for the order, location information for the bags (e.g., one or more shelf or bin locations at a drive-up order fulfillment staging area), a quantity of items per bag, a listing of items in the order, vehicle identification information, special instructions or requests entered by the customer, an indication as to whether or not the order includes age restricted items (e.g., cold medicine, alcohol, etc.), and other information for the order. Refer to FIG. 2A for additional discussion about the user interface 120.

In some implementations, the computing device 118 can receive a notification, from the server system 116, that a customer is on their way to the fulfillment location at the store 106. The notification can include an order identifier that includes an order number for the customer's order and an indicator of the estimated time until the customer arrives at the store 106. In some implementations, the employee can select the notification or a control displayed as part of the notification to cause the computing device 118 to display a page of the order fulfillment application that includes additional details on the order, customer, or related info.

When the customer arrives for drive-up or pickup, a barcode or other identifier can be presented at the mobile device 102, which can be scanned by the employee using the computing device 118 and/or a scanning device to verify the customer's identity and verify that the order was provided to the customer. For example, the employee can retrieve the bags for the customer's order from appropriate storage bins located at or near the in-store pickup fulfillment location and provide the bags containing the order to the customer. The employee can then scan the barcode and the computing device 118 can provide a notification indicating that the scanned barcode matches the customer or their order to ensure that the employee has provided the correct order. Scanning of the barcode can also cause the computing device 118 to display information indicating that the customer has already paid for the order. In some implementations, another scannable code or identifier, such as a QR code, can be displayed, or a human readable numeric or alphanumeric code can be displayed on the customer's mobile device 102.

When the customer arrives to pick up an order, the user interface 120 can update to show that the customer has now arrived and has switched the estimated time of arrival indication for a particular order to a time since arrival timer. In other words, the timer can switch from a count-down timer indicating an estimated time until arrival to a count-up timer indicating the amount of time since the customer arrived. In some implementations, when the timer switches from a count-down, ETA timer to a count-up, time since arrival timer, the user interface 120 can change the appearance of the timer. For example, the timer can be displayed in grey during count-down and then can be displayed in green when the timer switches to a count-up timer. Other appearance changes, such as italics, bold, flashing, change in size, change in location, change in background color for the order, a box or circle around the timer, or other display change can be used to visually indicate to the employee that the customer has arrived and that the order fulfillment should be completed before the customer is waiting too long. If the timer runs for over a predetermined period of time since the customer arrived, the timer may be represented in a red color to warn the employee that the customer has been waiting too long. In some implementations, the count-up timer can be stopped or cleared in response to an event. For example, the employee can use one or more controls of one of the user interface screens of the computing device 118 to indicate that the order has been fulfilled. Completion of the order fulfillment can cause the timer to stop or be cleared.

FIG. 2A-Y show example user interface displays for computing devices in a drive-up order fulfillment system. FIG. 2A depicts the user interface 120 in which the employee at the computing device 118 can claim a task of preparing an order. As shown in the panel 126, the “In hold” tab is selected and presented in the user interface 120. The “In hold” tab shows orders that have either not been started to be removed from hold, or that are in the process of being scanned out of hold. Forty-two orders are currently categorized as “In hold” and thus presented in the panels 128 and 132.

Each of the orders in the panels 128 and 132 are presented with graphical elements, such as graphical elements 125, 127, and 129. For example, the server system 116 can provide, to each of a group or subset of the computing devices 118, information that, when processed by each of the computing devices 118, causes each of the computing devices 118 to display at least one graphical element (e.g., graphical icon) with each order in a list of orders in the panel 128 and/or 132. The at least one graphical element can provide a visual indication of a type of item associated with the respective order.

The graphical elements 125, 127, and 129 can be special handling icons, thereby indicating that an order contains one or more designated items (e.g., special items) that require special handling. The graphical elements 125, 127, and 129 can provide a quick visual reference to the employees of the subset of computing device 118 indicating what types of items are in each order. When the employees see such graphical elements, the employees can recognize that special actions may need to be taken when preparing and/or delivering the order in comparison to orders that do not contain such special items. For example, an order for “John Smith,” as shown in the panel 128, includes the graphical elements 125, 127, and 129.

The graphical element 125 is a milk carton and can be a quick reference icon for dairy products, such as milk, eggs, cheese, and butter. The graphical element 127 is an apple and can be a quick reference icon for fresh produce, such as fruit and/or vegetables. In some implementations, one or more graphical elements can be quick reference icons for fruit and one or more other graphical elements can be quick reference icons for vegetables. In some implementations, a single graphical element can be used to represent all items that require refrigeration, such as a graphical element that combines graphical elements 125 and 127. Graphical elements of food items, such as the graphical elements 125 and 127, can indicate that one or more items are located in a cooler, freezer, or other cold storage and thus should remain there until the customer is a predetermined amount of time away from the fulfillment location (e.g., 3 minutes away). The graphical elements 125 and 127 can also represent items that are maintained in cold storage for different lengths of time and/or are maintained in different hold locations in the fulfillment location. For example, the graphical element 127 can indicate fresh produce, which can remain out in room temperature locations for longer periods of time than dairy products represented by the graphical element 125. Particular types of produce, which can be represented by another graphical element, can also be left out in room temperature for longer periods of time than other types of produce. Similarly, particular types of dairy products, which can be represented by another graphical element, can also be left out in room temperature for longer periods of time than other types of produce. Moreover, particular types of refrigerated and/or frozen items can be represented by other graphical elements and can be left out in room temperature for longer periods of time than other items.

The graphical element 129 is a wine bottle and martini glass, which can be a quick reference icon for alcoholic beverages. The graphical element 129 can indicate an age-restricted item that may require special handling that complies with local laws, as described below.

Although the graphical elements 125, 127, and 129 demonstrate categories of items (dairy products, produce, and alcoholic beverages, respectively), such categories of items can also be divided into sub-categories. Each sub-category can be represented by one or more other graphical elements. For example, sub-categories of the graphical element 125 can include milk, eggs, cheese, yogurt, butter, juice, etc. Sub-categories of the graphical element 127 can include citrus fruits, avocados, mangos, berries, applies, cucumbers, potatoes, carrots, root vegetables, leafy vegetables, etc. Sub-categories of the graphical element 129 can include wine, beer, hard liquors, etc. In some implementations, the graphical element 129 can include sub-categories specific to local laws for alcoholic beverages. For example, a state or other local jurisdiction may have certain requirements or laws specific to selling beer, hard seltzers, and similar malt beverages and certain requirements or laws specific to selling liquors. Each set of requirements and/or laws can be categorized into a different sub-category and indicated as such with other graphical elements. One or more other sub-categories and graphical elements may be possible, as described below.

In the example of FIG. 2A, because the graphical elements 125, 127, and 129 are presented with the order for John Smith, an employee of the computing device 118 who takes the task of preparing and/or delivering this order can be aware, by looking at the graphical elements 125, 127, and 129, that the order contains some amount of dairy products, fresh produce, and alcoholic beverages. The employee therefore can become aware that John Smith's order contains special items that may require special actions in terms of preparation and/or delivery.

As described further below, the special actions can vary depending on the type of special items. For example, for dairy products and/or fresh produce, the employee may be notified to return a bag containing such items to cold storage if the bag is left out for longer than a threshold amount of time before John Smith arrives at the store. As another example, the employee may be notified to discard such items and replace them in the bag before John Smith arrives, depending on just how long the bag is left out of cold storage. As yet another example, the employee can be notified to check John Smith's government-issued ID before giving him a portion of the order that contains the alcoholic beverage(s). In yet some implementations, the employee may not be legally permitted to deliver the portion of the order containing the alcoholic beverage(s) to John Smith's vehicle upon his arrival. Rather, John Smith may be prompted to enter the fulfillment location and pick up the portion of the order containing the alcoholic beverage(s) while the rest of the order is delivered to John Smith's vehicle.

As yet another example, the portion of the order containing the alcoholic beverage(s) may not be delivered to John Smith if he arrives at the fulfillment location after a time that is set by state or local laws for the sale of alcohol. Some local jurisdictions may restrict the hours at which alcohol can be sold and picked up. If John Smith puts in the order for the alcoholic beverage(s) within the hours of sale and then arrives after the hours of sale, he may not be able to pick up the alcoholic beverage(s). Thus, the employee at the computing device 118 can receive an indication (such as the graphical element 129 changing color, blinking red, being highlighted in red, etc.) indicating that the alcoholic beverage(s) in John Smith's order should be cancelled and removed from a bag in the order. The employee can then deliver the rest of John Smith's order upon his arrival at the fulfillment location. John Smith would then have to place a new order for the alcoholic beverage(s) during hours at which alcohol can be sold and picked up. One or more other special actions may be possible, as described herein.

Still referring to FIG. 2A, at least 4 orders are still listed as “On the way” in the panel 132. Each of these orders also includes at least one graphical element providing a quick reference guide to employees of the subset of computing devices 118 about what items are contained in the order. For example, an order for “Donald Richards” includes the graphical elements 125 and 127, indicating that dairy products and fresh produce are contained in his order. Orders for “Stacy Williams” and “Sha Going” also include the graphical elements 125 and 127. An order for “Deborah Livingston” includes the graphical element 129, which indicates that her order contains alcoholic beverages.

One or more other graphical elements can be used to provide quick reference visual indications to the employees about what items are part of an order (and thus, what special actions may be required for those items). In some implementations, items in the order that do not require special handling (e.g., the items are not identified as or otherwise associated with special actions such as cold storage or age verification) may not be presented with graphical elements. For example, a graphical element can provide a visual indication of meat products. Another graphical element can provide a visual indication of frozen meat products. A graphical element can provide a visual indication of fish products. Another graphical element can provide a visual indication of frozen fish products. Another graphical element can provide a visual indication of pet supplies (e.g., food, treats, toys, beds, leashes, collars, etc.). One or more other graphical elements can provide visual indications of home goods (e.g., towels, bedding, sheets, pillows, blankets, dishes, silverware, pots, pans, mugs, appliances, plants, candles, etc.), children's products (e.g., diapers, baby clothes, children's clothes, toys, books, electronics, etc.), supplies (e.g., school supplies, books, journals, pens, pencils, crayons, office supplies, hardware, nails, screw drivers, power tools, etc.), garden supplies, clothing and accessories, hot prepared food, hot beverages (e.g., coffee, tea, etc.), and other types of items that may be sold or otherwise provided by the fulfillment location and that can be purchased online by customers at the computing devices 102.

As another example, a graphical element can provide a visual indication of medication or other pharmaceutical products. Special actions associated with the medication can include age verification (e.g., checking the customer's government issued ID), checking the customer's prescription to ensure the correct person is picking up the medication, and/or delivering the rest of the customer's order and requiring the customer to enter the fulfillment location to pick up the medication before the customer's entire order can be completed. As another example, a graphical element can provide a visual indication of tobacco products. Similar to the medication and/or alcoholic beverages, special actions can include age verification and/or delivering the rest of the customer's order and requiring the customer to enter the fulfillment location to pick up the tobacco products separate from the rest of the order.

A graphical element can also provide a visual indication of one or more types of electronic products. Some electronics may require activation upon purchase. For example, cellphones may require inserting a SIM card and/or setting up an account or phone number. Therefore, an employee of the fulfillment location can deliver everything in a customer's order except the electronic product (e.g., the cellphone). The customer may be required to enter the store to pick up and activate their electronic product. Some electronics may also require alarms or other security devices to be removed from the products upon purchase.

A graphical element can provide a visual indication of items over a certain price. The price can vary depending on the type of item and/or categorization of the item. Special actions can include delivering a rest of the customer's order to the customer's vehicle and requiring the customer to enter the fulfillment location to pick up the item that is over the certain price. Picking up high value items in the fulfillment location may be beneficial to prevent theft of such items when they are being moved through a parking lot to a customer's vehicle. Example items can include TVs, tablets, headphones, cellphones, jewelry, watches, furniture, and other items that may be classified as high value items or items over certain price thresholds.

A graphical element can also provide a visual indication of items over certain size measurements/dimensions. Threshold measurements can depend on the type of item and/or categorization of the item. This graphical element can be displayed, for example, for orders containing furniture, appliances, plants, TVs, and other large items (e.g., items that satisfy or are above certain threshold measurements/dimensions). Special actions can include delivering a rest of the customer's order to the customer's vehicle and requiring the customer to enter the fulfillment location to pick up the item. Special actions can also include requiring more than one employee to deliver the item to a customer's vehicle. Special actions may also include requiring an employee to get a large cart to move the item to the customer's vehicle in the parking lot.

In some implementations, a graphical element can also indicate which items may be retrieved from a retail environment or storage area only upon arrival of a customer. Thus, the items may not be prepared and put in hold locations before the customer arrives. In yet some implementations, a graphical element can also indicate which items may be currently stored (e.g., prepared and in a hold location) in a cold storage area (such as a freezer or refrigerator). In some implementations, a graphical element can indicate which items may be currently stored in a hold location in room temperature. One or more other graphical elements can also be used to provide quick reference visual icons to employees in the fulfillment location to prepare and deliver orders to customers.

In some implementations, graphical elements can also be presented to provide visual indications of types or categories of items that make up the order. For example, the order can include a food icon (indicating that at least one item in the order is a grocery item). The order can also include a beverage icon (indicating that at least one item in the order is an alcoholic or other adult beverage). The order can also include other icons or graphical elements that correspond to various other types and categories of items offered for sale (e.g., electronics, furniture, appliances, clothes, etc.). In some implementations, graphical elements can also be presented indicating particular areas, departments, or locations in the store where the items for the order originate from. For example, grocery items can be presented with a refrigerator or other food icon indicating that the grocery items come from a grocery section in the store. Pharmaceutical products can be presented with a pharmacy icon indicating that the pharmaceutical products come from the pharmacy location in the store. As another example, coffee or other beverages can be presented with a coffee icon indicating that the coffee or other beverages come from a coffee shop in the store. One or more other graphical elements and/or icons can be presented as described herein.

In the panel 128, one customer, John Smith, has arrived and has been waiting for 37 seconds. An indication 131 is presented with John Smith's order listing in the panel 128 to indicate a stage of preparation for this order. The indication 131 states “Prepping by Jennifer M.” The indication 131 can be presented in the user interface 120 at at least a subset of every computing device 118 of employees at the fulfillment location. Therefore, employees of the subset of computing devices 118 can be notified that the order is currently being prepared and therefore does not need to be claimed by another employee.

Orders that have not yet been completely prepared, can be shown with the control 138. The control 138 can be a red button with the text “Prep.” The control 138 can be presented next to each order listing, such as the order listing 134, in either panel 128 and 132 that has not yet been prepared. It can be preferred for employees to claim orders that appear in the “Arrived” panel 128 with the control 138 since those customers will be arriving sooner and thus likely waiting longer for their orders if those orders are not prepared.

As described above, when an employee claims an order for preparation by selecting the control 134, their name or other identifier can appear as the indication 131 in the user interface 120 presented at the computing devices 118 of the employee's coworkers. The indication 131 can appear in real time and/or near real time across all the computing devices 118 so that the coworkers can become aware that the order has been claimed. If another employee tries to select the control 134 for an order that has already been claimed, an error message can be presented at their respective computing device 118. As a result, no two employees can claim the same order at the same time.

Once the employee selects the control 134 for an order listing, the user interface 120 can be updated with order information as shown in FIGS. 2B-C. FIG. 2B shows an example user interface 200 when the employee selects a control to prepare a particular order (e.g., the control 134 in FIG. 2A). The user interface 200 can be an order preparation screen displayed at the computing device 118. Here, the employee has selected a control to prepare the order for customer “John Smith.” The user interface 200 indicates information such as when the customer is expected to arrive, vehicle identification information, an order or orders to be fulfilled, a hold location or multiple hold locations for the order, bags and associated with the order, quantities of items in each bag, and a selectable option 208 to complete preparation of the order. As shown, the option 208 may be grayed out and therefore not selectable until the preparation process has been completed for John Smith's order.

More particularly, the user interface 200 can include hold location indications 202A-N. The indications 202A-N can indicate identifying information for locations in the fulfilment location where bags for John Smith's order are held. As shown in FIG. 2B, bags for a same order can be spread out and stored in multiple different hold locations. Some hold locations may be refrigerated and thus used to store bags of items that need to remain cool/refrigerated/frozen before pickup. Some hold locations may be non-refrigerated and designated for bags containing grocery items that do not need to be refrigerated. Moreover, some hold locations may be non-refrigerated and designated for bags containing non-grocery items, such as electronics and clothes. One or more other types of hold locations are also possible.

The user interface 200 also includes indications 204A-N and 206A-N for bags that make up John Smith's order. Each of the indications 204A-N and 206A-N can be represented in a first indicia until the respective bags are scanned by the employee during the preparation process. The first indicia can be a color, such as black. Once the employee scans a bag, using their computing device 118 and/or a scanning device in the fulfillment location, the corresponding indication 204A-N and/or 206A-N can be updated in the user interface 200 to a second indicia. The second indicia can be another color, such as green. Once all the bags have been scanned and thus all the indications 204A-N and 206A-N are represented in the second indicia (e.g., green), the option 208 can become selectable (and thus no longer grayed out) so that the employee can complete the preparation process for the order presented in the user interface 200.

Here, the indications 204A-N represent bags for John Smith's order that are located in a hold location represented by the indication 202A and the indications 206A-N represent bags for John Smith's order that are located in a hold location represented by the indication 202N. The indications 204A-N and 206A-N are graphical depictions of bags. Each of the indications 204A-N and 206A-N also includes a numeric value indicating how many items are in each respective bag. In the example of FIG. 2B, there are 9 indications 204A-N for 9 bags located in the hold location 202A and 2 indications 206A-N for 2 bags located in the hold location 202N. Each of the 9 bags in the hold location 202A have 1 item while one bag (as shown by the indication 206A) in the hold location 202N has 3 items and another bag (as shown by the indication 206N) in the hold location 202N has 4 items.

FIG. 2C shows the bag indication 206N represented in the second indicia, such as a green color or other pattern. This means that the employee has scanned the bag represented by the indication 206N in the hold location represented by the indication 202N. As the employee scans each remaining bag for John Smith's order, the respective indications 204A-N and 206A-N in the user interface 200 may be updated to the second indicia as well.

Referring to both FIGS. 2B-C, the employee may prepare and deliver John Smith's order. In that scenario, the employee may scan all the bags represented by the indications 204A-N and 206A-N once, during the preparation process. If, however, a different employee delivers John Smith's order, then the employee may scan the bags out of the hold locations and the different employee may also scan the bags to verify they are accurate after selecting an option to deliver the order to John Smith. During the preparation process, the employee may go to each hold location in the fulfillment location represented by the indications 202A-N and scan each of the bags for the order represented by the indications 204A-N and 206A-N. Once all the bag indications 204A-N and 206A-N are represented in the second indicia, the employee can swipe the option 208 across the bottom of the user interface 200. As described throughout this disclosure, swiping the option 208 can cause John Smith's order to be moved to the “Guest ready” tab. Once moved to the “Guest ready” tab, the order may no longer be assigned to the employee who prepared it during the preparation process.

In some implementations, the employee may make order adjustments in the user interface 200. The employee can make price adjustments by clicking or selecting one of the indications 204A-N or 206A-N. As described herein, selecting one of the indications 204A-N or 206A-N can cause information about items in the respective bag to be presented in the user interface 200. The employee can select an item presented in the user interface and an option to change a price of the selected item as well as a reason for changing the price. Selectable reasons for changing the price can include, but are not limited to, “Match store price,” “Item is damaged,” “Other,” etc. The employee can then input a new price and/or a percent to be taken off the price of the item. The price can be updated in the information presented about the selected item. The employee can then select the updated price to apply that price to the particular order. The price can then be presented in the user interface 200 with a green box, highlighting, or other indicia to indicate the price change and that the price change has been accepted and applied.

In some implementations, the employee can also make quantity adjustments by clicking one of the indications 204A-N or 206A-N. Similar to price adjustments, with quantity adjustments, the employee can select a reason for the quantity adjustment and input a value indicating the new quantity for a particular item in the respective bag.

FIG. 2D depicts information presented in the user interface 120 when the employee has selected “Guest ready” from the panel 126. As described above, orders that are prepared can be added to the “Guest ready” tab, as shown in FIG. 2D. Here, the panels 128 and 132 are updated to indicate which of the prepared orders are ready to be delivered to customers who are waiting and customers who are still on their way. In the example of FIG. 2D, three customers are waiting for their orders at the fulfillment location. The customer's orders are listed in the panel 128 from order of first to arrive. Each order can include information indicating how long the customer associated with the order is waiting. The employee can select a control 220A-N next to any of the orders listed in the panels 128 and 132 to claim a task of delivering the respective order to the customer. The controls 220A-N can be buttons with an indication of “Deliver.” The controls 220A-N can be similar to the controls 134 previously described.

FIG. 2E depicts information presented in the user interface 120 when the employee selects the control 220A to deliver John Smith's order (refer to FIG. 2D). As shown, the control 220A can be replaced with an indication 222 indicating that the task of delivering John Smith's order has been claimed. Identifying information of the employee, such as their name or an employee ID, can be presented in the indication 222. The indication 222 can be presented in the user interface 120 of each computing device 118 of the employees in the fulfillment location. As a result, the other employees in the fulfillment location can be made aware in real or near real time that John Smith's order has been claimed by the employee.

Referring to both FIGS. 2D-E, if a customer has arrived, their order appears in the panel 128 and their orders should be prioritized over orders for customers whose orders appear in the panel 132. However, employees may still stage an order in the panel 132 in preparation for the customer's arrival such that the customer does not have to wait an extended period of time when they arrive at the fulfillment location.

The indication 222, as mentioned above, can indicate that an employee claimed the task of delivering the order to the respective customer. Additional or other employees may not work on this order unless the employee backs out and cancels their claim. The employee can cancel their claim to deliver the order similarly to canceling their claim to prepare the order described previously. If the employee cancels the task to deliver the order, the indication 222 can be replaced with the respective control 220A-N in the user interface 120 presented at each computing device 118 of the employees in the fulfillment location. As a result, any other employee in the fulfillment location can now claim the task of delivering that order. Moreover, as mentioned previously, if an employee claims the task of delivering an order but did not prepare that order during the preparation process, then the employee may have to scan all the bags and/or items associated with the other prior to delivery to ensure that the bags are accurate and that no bags and/or items are missing for the order.

Once the user selects a control 220A-N, the user interface 200 discussed in FIGS. 2B-C can be presented at the computing device 118. If the employee delivering the order also prepared the order, the employee's prior scans can be retained and another user interface can be presented at the computing device 118 including a 4-digit code or other identifier used for confirming the customer associated with the order. After all, all the indications 204A-N and 206A-N of the bags may be represented in the second indicia, indicating that all of the bags have been scanned out of the hold locations for the particular order. If the employee delivering the order did not scan the bags during preparing, then a second set of scans may be required. Thus, the employee may scan every bag for the order, as described in reference to FIGS. 2B-C until all the indications 204A-N and 206A-N are represented in the second indicia. The employee can then swipe or select the option 208, which can present the another user interface at the computing device 118 including the 4-digit code or other identifier used for confirming the customer associated with the order. The employee can then enter (e.g., type in) the 4-digit code into an input field in the another user interface to confirm delivery. Once the delivery is confirmed, the respective order may be removed from the “Guest ready” tab described in FIGS. 2D-E and thus updated across all the computing devices 118 of the employees in the fulfillment location.

FIG. 2F depicts a user interface 224 at the computing device 118 for order preparation. The user interface 224 is similar to the user interface 200 described in FIGS. 2B-C. In this example, the employee selected the control 220A in FIG. 2D to deliver the order for John Smith, who has arrived at the fulfillment location. By selecting the control 220A, the user interface 224 can be presented at the employee's computing device 118 while the control 220A is updated to the indication 222 (refer to FIG. 2E) across the other computing devices 118 of the other employees.

From the user interface 224, the employee can scan bags for John Smith's order (or orders) out of hold locations, as described above in FIGS. 2B-C. As mentioned previously, sometimes the employee delivering the order to a customer may not be the same employee who prepared the order. Thus, the employee delivering the order would have to scan the bags out of the hold locations as part of the delivery process. Accordingly, the steps of scanning the bags out of the hold locations described in reference to FIGS. 2F-G can be performed during a preparation stage of an order as well as during a delivery stage of the order.

The user interface 224 includes a field 230 that indicates that the customer John Smith has arrived. The field 230 includes a timer indicating the amount of time that has elapsed since the customer has arrived. In some implementations, prior to arrival of the customer, the field 230 may include an indicator of “order placed” or “on the way” to indicate the customer's status (e.g., refer to FIGS. 2B-C). For example, the field 230 can indicate that the customer is on the way and the timer can indicate an ETA for the customer. The field 230 further includes vehicle identification information for the customer to allow the employee to more easily identify the customer's vehicle when bringing the customer's order items to the drive-up fulfillment location in the parking lot of the fulfillment location. The field 230 further may include an icon, such as a car, indicating that the order(s) for the customer are drive-up fulfillment orders (rather than in-store pickup, delivery, etc.).

Additionally, the field 230 can be represented in different indicia, such as colors (e.g., patterns, boxes, highlighting, etc.), based on how long the customer is waiting. For example, if the customer has just arrived and is waiting for less than a threshold period of time, according to the timer, the field 230 can be represented in a first indicia, such as a green color. If the customer now waits for more than the threshold period of time, according to the timer, the field 230 can be updated and represented in a second indicia, such as a red color. Furthermore, as shown in FIGS. 2B-C, if the customer is on their way, the field 230 can be represented in a third indicia, such as a grey or other neutral tone.

Still referring to the FIG. 2F, the user interface 224 includes a field 226A indicating a first order for the customer, along with an order number for the order. The field 226A can include a checkbox that can be selected when the employee wants to take an action with respect to the order indicated by the field 226A. For example, the employee can select the checkbox and then select control 233 to take one or more actions with respect to the selected order, such as indicating that the employee has taken ownership of completing the order and delivering it to the customer's vehicle.

Sub-fields 232A and 232B nested under the field 226A indicate where the purchased items for the order are located, or their hold locations. For example, the field 232A includes an indication of “SD007,” which can indicate that part of the order is located at a particular shelf, bin, or other hold location. The field 232A also includes indicators 234A and 234B for bags that are at the indicated location. In the example depicted, the field 232A indicates that there are 2 bags for the order located at location SD007, with each bag having 1 item. Similarly, field 232B includes indicator 234C indicating that 1 bags for the order is located at location SD008. The information in the fields 232A and 232B can ensure that the employee gathers the correct bags and number of bags to complete the customer's order.

In some implementations, multiple active orders can be associated with a single customer. For example, a customer may place a first order for drive-up fulfillment and later realize that they would like to purchase additional items and make a second order for drive-up fulfillment. Field 226N indicates a second active order associated with the customer John Smith. The field 226N, like the field 226A, includes a checkbox that functions in a similar manner described above. For example, the employee can select both checkboxes and to take actions with respect to both orders for the customer. Sub-field 232C nested under the field 226N indicates that the second order contains bags located at hold location “SD002” and sub-field 232N indicates that the second order also contains bags located at hold location “SD001.” The sub-field 232C also includes an indicator 234D indicating that there is 1 bag having 5 items for the second order is located at the hold location SD002. The sub-field 232N includes an indicator 234N indicating that 1 bag having 5 items for the second order is located at the hold location SD001.

In the example of FIG. 2F, the employee has not scanned any of the bags represented by the bag indicators 234A-N out of their respective hold locations. Therefore, all of the indicators 234A-N are presented in a first indicia, such as a black color. Moreover, the option 208 presented at the bottom of the user interface 224 is unselectable and greyed out. As described throughout this disclosure, the option 208 may not become selectable and another color, such as red, until all the bags for the order(s) have been scanned out of their hold locations and the indicators 234A-N have been updated to a second indicia, such as a green color.

FIG. 2G depicts the user interface 224 as the employee scans bags out of their respective hold locations for John Smit's order(s). Here, the field 230 has been updated to a red color, indicating that the customer is waiting for more than a threshold period of time. This can prompt the employee to work efficiently and quickly to complete the order. For the order represented by the field 226A, the employee has scanned the bag associated with the indicator 234A out of the hold location SD007. As a result, the indicator 234A is represented in the second indicia, such as the green colored bag. However, the bag associated with the indicator 234C needs attention, as the indicator 234C is now represented with a graphical element 235 such as a hazard symbol, yellow/orange triangle, and/or exclamation point. The graphical element 235 can be presented in the user interface 224 to bring the employees attention to the corresponding bag before completing the order. The graphical element 235 can be presented or overlaying a portion of the bag indicator 234C if an item or items in the respective bag have been cancelled from the order by the customer, recalled, etc. When the graphical element 235 is presented, the employee can select the indicator 234C to be presented with information about the respective bag. For example, the information can indicate a particular item(s) and quantity of the item(s) that has been cancelled in the respective bag. The employee can locate the bag in the fulfillment location (e.g., in a hold location) and remove the appropriate quantity of the item(s) from the bag. The employee can put the removed item(s) back in its respective location in the fulfillment location (e.g., on a shelf on a retail floor). The employee can also select an indication presented at the user interface 224 to confirm that the employee removed the quantity of the particular item(s) from the bag. Refer to FIGS. 2I-K for additional discussion.

FIG. 2H depicts the user interface 224 once the employee has scanned all the bags out of hold locations for the customers order(s). The field 230 still appears in the red color and the timer shows that the customer John Smith has been waiting longer since they arrived at the fulfillment location. The employee has scanned all the bags for the order represented by the field 226A, as shown by the bag indicators 234A-C appearing as green bags. The employee has also scanned all the bags for the order represented by the field 226N, as shown by the bag indicators 234D and 234N appearing as green bags. Because all the bags have been scanned for John Smith's orders, the option 208 can now appear selectable and in another indicia, such as having a red circular element 209. The employee can hold down on the red circular element 209 and swipe towards the right of the option 208. This action can cause the preparation to be completed for John Smith's orders. As previously described, by selecting the option 208, another user interface can be presented at the computing device 118 for the employee to input a 4-digit code or other identifier provided by the customer and used to verify the customer and complete delivery to that customer.

FIG. 2I depicts the user interface 224 when the employee selects one of the indicators 234A-N for a bag that has been scanned out of its hold location. Here, the employee has selected (e.g., tapped/clicked on) the indicator 234D for the bag held at location 232C (refer to FIG. 2H). As a result, a pop out window 236 overlays a bottom portion of the user interface 224. The rest of the user interface 224 may appear shaded or otherwise in a darker or lower lighting so that the employee can focus on information presented in the pop out window 236.

The pop out window 236 can present information such as a quantity of items in the selected bag, a hold location of the selected bag, a selectable graphical element depicting each item in the selected bag, information 238 about status of bag scanning, and a menu 240. The employee can click or tap the selectable graphical element to view a user interface with item information (e.g., an item listing that would be presented in an online retail environment to consumers). The information 238 can indicate whether the selected bag has been scanned out of the hold location. The information 238 can include a graphical element, such as a barcode with a checkmark overlaying it indicating that the bag has been scanned out of hold. The menu 240 can be clicked, tapped, or otherwise selected to view one or more actions that the employee can take to manually scan the bag out of the hold location, as described below in reference to FIGS. 2J-K.

FIG. 2J depicts the user interface 224 when the employee selects one of the indicators 234A-N for a bag that has not been scanned out of its hold location. For example, the server 116 described in FIG. 1 can receive, from the computing device 118 of the employee, an indication of user selection of an indication of a bag of the one or more bags presented in the user interface 224. The server 116 can then provide, to the computing device 118, information that, when processed by the computing device 118, causes the computing device 118 to display a pop out window 236 that overlays a portion of the user interface 224, the pop out window 236 including information about items in the selected bag, the information also including selectable options for completing a hold on the selected bag.

Here, the employee has selected the indicator 234D for the bag held at the location 232C (refer to FIG. 2H). However, unlike FIG. 2I, the pop out window 236 includes information 242. The information 242 indicates that the selected bag has not been scanned out of its hold location. The information 242 also includes a graphical element of a barcode with an X across it or another indicator indicating that the selected bag has not been scanned out of its hold location. The information 242 can prompt the employee to scan the bag to complete the hold. Therefore, the employee may manually scan the bag out of its hold location, such as when there is an issue reading or otherwise scanning labels on bags or the employee does not have a scanning device, using one of the selectable options from the menu 240.

FIG. 2K depicts selectable options from the menu 240 when the employee is completing a manual hold on the selected bag. Selecting or tapping on the menu 240 can cause a window 241 to appear over a portion of the pop out window 236. The window 241 can include one or more selectable options. Here, the window 241 includes options to “Remove from hold,” “Put back to hold,” and “Transfer hold.” One or more other options may also be presented in the window 241. In the example of FIG. 2K, the employee can select the option to “Remove from hold” in order to manually remove the selected bag from its hold location. Thus, the employee may select this option instead of scanning a label on the selected bag when removing the bag from its hold location. Selecting the option to “Remove from hold” can cause the indicator 234D for the bag to update to the second indicia, such as a green bag color, as shown in FIG. 2H.

Therefore, the server 116 can receive, from the computing device 118, an indication of user selection of an option from the selectable options to complete the hold on the selected bag. The server 116 can then provide, to the computing device 118, information that, when processed by the computing device 118, causes the computing device 118 to display the selectable option to complete the preparing of the order in the user interface 224 based on the user selection of the option to complete the hold on the selected bag.

FIG. 2L depicts a user interface 244 for displaying a report for out of hold orders. The out of hold orders report can be checked by employees to get a better sense of how the employees handle interactions and completion of orders with customers. The report can be checked daily. The report can also be checked multiple times throughout a day. The report can be accessed by selecting a menu option presented in the user interface 120. The menu option can be three horizontal lines outputted in a top left corner of the user interface 120, as shown in FIGS. 2D-E. From that menu option, the employee can select an option for “out of hold orders,” which can cause the user interface 244 to be presented at the computing device 118.

The user interface 244 can include selectable tabs 246 and 248. The tab 246 can be selected to view “Oldest” out of hold orders. The tab 248 can be selected to view “Newest” out of hold orders. In the example of FIG. 2L, the employee has selected the tab 246. Since the tab 246 is selected the test “Oldest” on the tab is bolded and a red horizontal line appears beneath the tab 246. Information can be presented in the tab 246 in one or more sub-fields 250A-N. For example, sub-field 250A can represent out of hold orders that are “cancelling tonight,” sub-field 250B can represent out of hold orders that are “cancelling tomorrow,” and sub-field 250N can represent out of hold orders that are “canceling in 2+ days.” Each of the sub-fields 250A-N can include text indicating what out of hold orders are associated with that sub-field and how many orders are associated.

FIG. 2M depicts the user interface 224 when the employee decides to cancel an entire order. As mentioned above, the employee can cancel an order that they have claimed to prepare. After selecting a control to prepare a customer's order, the user interface 224 is presented at the computing device 118. The field 230 indicates that the customer John Smith is on his way to the fulfillment location. The employee can select any of the checkboxes next to orders presented in the user interface 224 then click (e.g., select, tap on) a menu option 252.

FIG. 2N depicts the user interface 224 with selectable options to manage an order presented therein. By clicking on the menu option 252 in FIG. 2M, a window 254 can be presented to overlay a portion of the user interface 224. The window 254 can include one or more selectable options for actions that can be taken for an order or orders. In FIG. 2N, the employee selected a checkbox next to an order represented by sub-field 255 in the user interface 224. The window 254, which appears once the employee selects the menu option 252 (shown in FIG. 2M), lists three actions for the selected order: “Cancel orders,” “Order notes,” and “Put all bags to hold.” Here, the employee can select the action to “Cancel orders,” which can cause the entire order represented by the sub-field 255 to be cancelled.

FIG. 2O depicts the user interface 224 once the employee selects the action to “Cancel orders” described in FIG. 2N. Once the employee selects the action to “Cancel orders,” a pop out window 256 can appear over a portion of the user interface 224. The rest of the user interface 224 can be presented in a darker shade or lighting so as to focus the employee's attention on information presented in the pop out window 256. The pop out window 256 can present selectable options as reasons for canceling the selected order (or orders). For example, the employee can select reasons that include “Guest request,” “Ring up at POS,” or “Other.” One or more other reasons can also be presented in the pop out window 256.

The employee can select “Guest request” if the customer requests to cancel the order and/or the customer cancels the order from their device. By selecting this reason, the employee may then return items for that order to locations on a sales floor. The employee can select “Ring up at POS” if the employee intends to ring the entire order up at a POS in the fulfillment location instead of bringing the entire order out to the customer's vehicle. The employee can select “Other” if another reason exists for canceling the order. In some implementations, the employee may be prompted to provide input designated what the other reason is for canceling the order.

FIG. 2P depicts the user interface 224 once an order cancellation is completed. Once the employee selects a reason for canceling the order, as described in FIG. 2O, a window 258 can be presented over a portion of the user interface 224 indicating that the order was successfully cancelled. The employee can click on “Ok” presented in the window 258 to close out of the window 258 and return to the user interface 224. In some implementations, once the order is successfully cancelled, hold location information may disappear from the user interface 224 but items may still be viewable.

FIG. 2Q depicts the user interface 224 when the employee chooses to cancel multiple orders at once. Referring back to the FIGS. 2M-N, the employee may not select any of the checkboxes for orders presented in the user interface 224. Instead, the employee may just select the menu option 252 and click on the option to “Cancel orders” in the window 254. Selecting the option “Cancel orders” when no checkboxes have been selected for orders in the user interface 224 can cause a pop out window 260 to appear over a portion of the user interface 224, as shown in FIG. 2Q. The pop out window 260 shown in FIG. 2Q can provide the employee with selectable checkboxes for all orders 262A-N associated with the customer John Smith in the user interface 224. The employee can select multiple checkboxes to cancel multiple orders at once. For example, the employee has selected the checkboxes for the orders 262A and 262N. The employee can then select a control 264, such as a button, to cancel the selected orders at once.

FIG. 2R depicts the user interface 224 for canceling an item in an order. Here, the employee can select the bag indicator 234C in the hold location 232B for the order represented by the sub-field 226A. Selecting the bag indicator 234C can cause information about the selected bag to be displayed in the user interface 224, as described in reference to FIG. 2S.

FIG. 2S depicts the user interface 224 with information about the bag that was selected in FIG. 2R. When the employee selects the bag indicator 234C in FIG. 2R, a pop out window 266 can overlay a portion of the user interface 224, as shown in FIG. 2S. The pop out window 266 can include information about the selected bag, as described in reference to FIGS. 2I-K. As previously mentioned, the pop out window 266 can include a selectable graphical element 268 for each item in the selected bag. Here, the selected bag contains 5 of the same item. Thus, the pop out window 266 includes the graphical element 268 for all 5 items. The graphical element 268 can be a tile with an image of the item, a title for the item, an item identifier (e.g., barcode, SKU, etc.), and one or more other information about the item. Selecting (e.g., clicking, tapping) the graphical element 268 can cause additional information about the item to be presented at the computing device 118, as described in FIG. 2T.

FIG. 2T depicts a window 270 that can be presented at the computing device 118 when the employee selects the graphical element 268 representing an item(s) in the selected bag shown in FIG. 2S. The window 270 can be presented over an entire portion of a display screen of the computing device 118. In some implementations, the window 270 can be presented to overlay a portion of the user interface 224, like the pop out window 266 depicted and described in FIG. 2S.

The window 270 can include information about the selected item, including an image of the item, a price of the item, a quantity of the item for the particular order, a title of the item, and a control 272. The control 272 can be a button with text indicating “Cancel items.” The control 272 can be clicked (e.g., tapped, selected) by the employee to cancel the items from the order presented in the window 270. In some implementations, clicking on the control 272 can cause a pop out window to be displayed that prompts the employee to confirm the quantity of the item that is going to be cancelled. The employee can confirm the quantity and then remove those items from the bag and put the items back on a sales floor so that the cancelled items are not delivered to the customer. Moreover, in some implementations, if the employee reviews contents of the selected bag and determines that the selected items are missing from the bag, the employee can click on the control 272 to cancel the selected items.

FIG. 2U depicts the user interface 224 with a pop out window 274 indicating that an item or items were successfully cancelled. Once the employee clicks the control 272 and confirms the quantity of items being cancelled in FIG. 2T, the pop out window 274 depicted in FIG. 2U can be presented at the computing device 118. The window 270 can be replaced with the user interface 224 and the pop out window 274 displayed over a portion of the user interface 224. The pop out window 274 can indicate that “Items were successfully cancelled.” The employee can then click on an “Ok” presented in the pop out window 274 to close out of the window 274 and return to the user interface 224.

FIG. 2V depicts the user interface 224 when an order has a partial cancel. The user interface 224 can include a sub-field 275 for an order having a partial hold. The sub-field 275 can further include an indicator 276 for a bag associated with the order having the partial hold. The indicator 276 can be a graphical element of a bag including a numeric value indicating a quantity of items in the bag. The indicator 276, as shown in FIG. 2V, may also include a symbol such as a hazard symbol, yellow/orange triangle, and/or an exclamation point to focus the employee's attention on the bag having the partial hold. Thus, the symbol can indicate that the bag contains at least one item having an issue. Selecting the indicator 276 can cause additional information to be presented in the user interface 224, as described in reference to FIG. 2W.

FIG. 2W depicts the user interface 224 with additional information about an order having a partial hold. As mentioned in FIG. 2V, the employee can select the indicator 276 for the bag having the partial hold, which can cause a pop out window 278 to overlay over a portion of the user interface 224, as shown in FIG. 2W. The pop out window 278 can indicate that a particular item in the bag has been cancelled by the customer. The pop out window 278 can include a selectable control 280 to “Remove cancelled item” from the bag. The employee can select the control 280 and physically remove the item that was cancelled by the guest from the bag.

Once all the items that have been cancelled by the guest are removed from the bag, the indicator 276 described in FIG. 2V can be updated from a black or grey bag to a green bag. The employee can then proceed with continuing and completing the order presented in the user interface 224.

FIG. 2X depicts the user interface 224 with additional information about an order having a partial hold. As mentioned in FIGS. 2V-W, the employee can select the indicator 276 for the bag having the partial hold, which can cause a pop out window 282 to overlay a portion of the user interface 224, as shown in FIG. 2X. The pop out window 282 is similar to the pop out window 278 described in FIG. 2W. In the example of FIG. 2X, the pop out window 282 indicates multiple different items that have been cancelled by the customer. The pop out window 282 can also include information 284 indicating that the employee should scan the bag to complete the hold (e.g., perform a manual hold). The employee can select menu option 286 to be presented a window 288 having selectable options for manually removing the bag from hold. The window 288 can include options for “Remove from hold,” “Put back to hold,” and “Transfer hold.” The employee can select the option to “Remove from hold,” which can cause the pop out window 278 described in FIG. 2W to be presented at the computing device 118. Thus, the employee may remove the items that were cancelled by the customer from the bag that has been manually removed from hold. In some implementations, selecting the option to “Remove from hold” can cause a pop out window 290 shown in FIG. 2Y to be presented at the computing device 118.

FIG. 2Y depicts the user interface 224 with the pop out window 290 for shopping items that have been cancelled by the customer. As mentioned above, if multiple items are cancelled by the customer, the pop out window 290 can be presented to the guest at the computing device 118. The pop out window 290 can indicate whether the cancelled items should be reshopped for the order. In FIG. 2Y, the pop out window 290 indicates that “An RTS task will not occur for this cancellation,” which means that the cancelled item does not have to be reshopped.

As described throughout this disclosure, once all the cancelled items have been removed from the bag or bags, the employee can continue with completing preparation and/or delivery of the order to the customer.

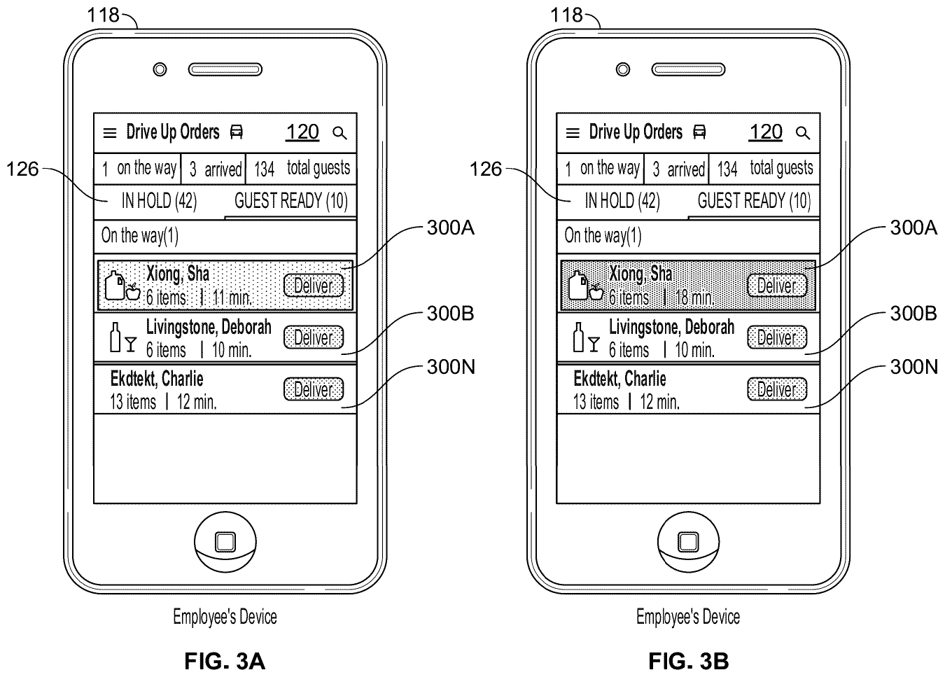

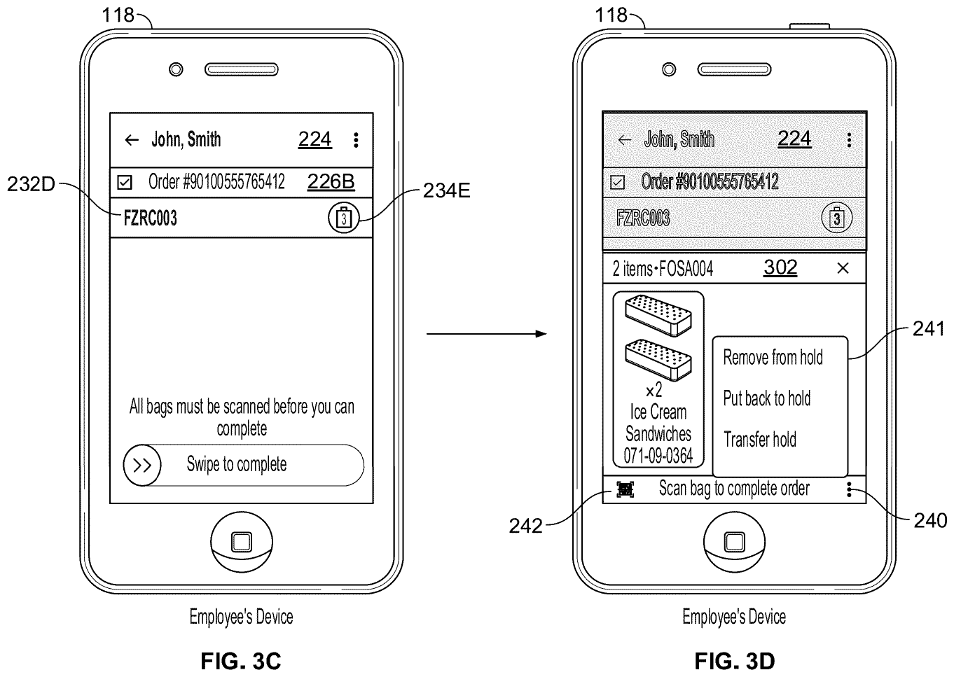

FIGS. 3A-D show example user interface displays for ensuring food safety of perishable items in a drive-up order fulfillment system. Perishable items, such as dairy products, some meats, frozen items, and/or some produce, may only be able to stay out in room temperature for certain periods of time before they should be returned to cold storage. If such items remain out in room temperature for more than predetermined periods of time, the items may spoil or otherwise decrease in quality. The period of time that the perishable items can remain in room temperature hold locations can vary depending on the type of perishable items. As an illustrative example, frozen pizzas or frozen vegetables may be able to remain in room temperature hold locations for longer periods of time than fresh meat, fresh produce, butter, and/or milk. As another example, eggs and cheese may be able to remain in room temperature hold locations for longer periods of time than other dairy products, such as milk, butter, and yogurt.

A customer's estimated time of arrival (ETA) can be used as an indication to the employees of the computing devices 118 for when to begin scanning the perishable items, or other temperature-controlled items, out from hold locations. As an illustrative example, once the customer is 3 minutes or less from arrival at the fulfillment location, an employee can be notified at the computing device 118 to begin scanning the perishable items out of the hold locations. As a result, the perishable items can be kept in their respective cooler, refrigerator, freezer, or other cooling unit hold location for as long as possible before the customer arrives to ensure quality and increased food safety. Moreover, items still have travel time home with the customer, so any extended period of time at room temperature can compromise the items' quality and increase food safety risk.

If a customer's order does not include graphical elements indicating such perishable items, then the employees may not have to worry about timing the scanning of items out of hold locations. For example, if a graphical element associated with a customer's order indicates canned goods and non-perishable items, then an employee at the computing device 118 can scan the items for that order at any time before the customer arrives since the items will not go bad if they are out in room temperature for extended periods of time.

Referring to the FIGS. 3A-D, FIG. 3A depicts the user interface 120 when “Guest Ready” is selected in the panel 126 and items for an order should be returned to an original cold storage hold location. The user interface 120 shows that customers for orders 300A, 300B, and 300N are on the way to the fulfillment location. The order 300A contains perishable items as shown by the graphical elements of dairy products and fresh produce (refer to FIG. 2A for additional discussion about the graphical elements). The order 300A also indicates that the items in this order have been scanned out of their hold location(s) and have been awaiting customer arrival for 11 minutes. The items therefore can be in a room temperature area for 11 minutes.

When items in an order are awaiting customer arrival for more than a threshold amount of time, the order can be represented in an indicia to alert the employee at the computing device 118 (or employees at a subset of the computing devices 118) to return the items in that order to their respective cold storage hold location(s). The threshold amount of time can vary depending on the type of item, as described above. In some implementations, the threshold amount of time can be the same for all refrigerated, frozen, and/or perishable items. In the example of FIGS. 3A-D, the threshold amount of time can be 10 minutes. Therefore, if an order contains perishable items and those items are scanned out of hold and put in a room temperature area for more than 10 minutes, the order can be represented in the indicia to alert the employee to return those items to their respective cold storage hold locations until the customer arrives (or until a threshold amount of time before the customer arrives, such as 3 minutes before arrival).

The indicia can be highlighting the order. The indicia can also be changing a color of text or graphical elements of the order. For example, the order can be highlighted in a yellow box to alert the employee. Text in the order can also be changed from a black color to a red color to alert the employee. One or more other indicia can be used to alert the employee that the items in the order should be returned to their respective cold storage hold location. For example, a hazard or warning icon or an exclamation point icon can be displayed over a portion of the order 300A to indicate that one or more items have been outside of cold storage beyond a predetermined threshold period of time.

In the example of FIG. 3A, the items in the order 300A have been out in the room temperature area for 11 minutes. Since this is over the threshold amount of time (e.g., 10 minutes), the order 300A can be highlighted and visually represented in a yellow box (e.g., the first indicia). This can alert the employees of the subset of computing devices 118 that the items in the order 300A should be returned to their respective cold storage hold locations to prevent spoilage or otherwise reduced quality of the items before the customer arrives. Any of the employees in the fulfillment location can claim the task of returning the items for the order 300A to their cold storage hold locations, as described throughout this disclosure. Once the employee returns the items for the order 300A to their cold storage hold locations and confirms this action at the computing device 118, the order 300A can be updated across all of the subset of computing devices 118 by removing the yellow highlighting. Therefore, all the employees can be notified that the order 300A has been appropriately taken care of.

FIG. 3B depicts the user interface 120 when an order has not been returned to a cold storage hold location after the employees of the subset of computing devices 118 have been alerted to return the order to the cold storage hold location. For example, it can be determined whether items in an order have been logged as being returned to their respective cold storage hold location within a threshold amount of time of being at room temperature. If the items have not been returned to their cold storage location(s) within the threshold amount of time, then the order can be represented in another indicia in the user interface 120, such as a red highlighting and/or a red box. After all, the items have exceeded a risk tolerance level for food quality and safety for the particular fulfillment location. If the items have been returned to their cold storage location(s) within the threshold amount of time, then the indicia that was added to the order in FIG. 3A can be removed. Thus, the order can be presented normally in the user interface 120 without any highlighting and/or box surrounding it.

The threshold amount of time can start from a time that the items for the order are logged as being removed from their cold storage hold locations and put in a room temperature area before delivery to a customer. This threshold amount of time can vary depending on the type of item. In some implementations, the threshold amount of time can be the same for all perishable items, all refrigerated items, and/or all frozen items. In the example of FIGS. 3A-D, the threshold amount of time can be 15 minutes for all perishable items. As another example, the threshold amount of time can be shorter for items like milk and butter (e.g., 11 minutes) and longer for items like vegetables and fruits (e.g., 20 minutes). In such examples, the threshold amount of time could be even longer for hot items such as hot prepared foods or hot beverages such as coffee or tea beverages. For example, the threshold time for coffee and other hot beverages can be set to 30 minutes. If the threshold is exceeded, the hot beverage is discarded and either remade for the customer or removed from the customer's order so that the customer is not charged. Items that are more likely to spoil from being out in room temperature (or faster to spoil) can have shorter threshold amounts of time that items that are less likely to spoil (or slower to spoil).

In some implementations, the threshold amount of time can start once the employees are notified to return the items of the order to their respective cold storage hold locations. For example, once the user interface 120 is updated to show an order in the indicia of a yellow highlighting or yellow box, a timer can begin. The timer can run until an employee confirms that they returned the items for that order to their respective cold storage hold location(s). Once the timer hits some threshold amount of time (e.g., 5 minutes since notifying the employees to move the items to the cold storage hold locations) and the items have not been returned to the cold storage hold location(s), the order can be shown in another indicia, such as a red highlighting or red box.

Moreover, when an order is represented in the another indicia (e.g., the red highlighting or the red box), the employees of the subset of computing devices 118 can also receive notifications, alerts, or other types of messages prompting the employees to take one or more additional actions associated with the order. For example, an employee may be notified to remove one or more items from the order that might have spoiled or lowered in quality since being out in room temperature for over the threshold amount of time. The employee may be notified to cancel one or more items from the order for the same or similar reason(s). In some implementations, the employee may be notified to replace one or more items in the order for the same or similar reason(s).

As shown in FIG. 3B, the order 300A is now represented in the another indicia—the order 300 is depicted in red highlighting instead of the yellow highlighting depicted and described in FIG. 3A. The order 300A is depicted in the red highlighting because the order 300A has been out in room temperature for 18 minutes because the items in the order 300A have not been returned to their respective cold storage hold locations after the employees were notified to return the items in the order 300A to the cold storage hold locations (refer to FIG. 3A).

FIG. 3C depicts the user interface 224 once an employee selects an order that needs to be returned to its cold storage hold location at the computing device 118. The employee can select an order that is represented in the yellow highlighting indicia as shown in FIG. 3A. The employee can select the order by clicking or pressing on a selectable option, such as a button indicating “Deliver.” Upon selecting that order, the employee can be presented with the user interface 224 shown and described in FIG. 3C. The user interface 224 in FIG. 3C is similar to the user interface 224 described above. In brief, the user interface 224 can present a field 226B (like the field 226A in FIG. 2F) indicating an order for a particular customer. The field 226B also includes sub-field 232D, which indicates a hold location for the item(s) in the order. The sub-field 232D includes indicator 234E representing a bag and quantity of items in that bag for the order at the location represented by the sub-field 232D.

In the example of FIG. 3C, 3 items are in a bag at a hold location called “FZRC003,” which can be a cold storage location, such as a freezer. The employee can select the particular order represented by the field 226B by selecting or tapping on a checkbox next to the order identifier (e.g., an order number in a header of the field 226B). The employee can then click on or select the indicator 234E to view a pop out window with options for putting the items in the bag represented by the indicator 234E back into cold storage hold location(s). Refer to FIG. 3D.

FIG. 3D depicts the user interface 224 with a pop out window 302 having options to put items in an order back in a respective cold storage hold location(s). When the employee clicks on or selects the indicator 234E shown in FIG. 3C, the pop out window 302 can be presented over a portion of the user interface 224, as shown in FIG. 3D. The pop out window 302 can include information about items that are in the selected bag.

The pop out window 302 includes the information 242, which indicates that the employee can scan the bag to complete the hold. The pop out window 302 also includes the menu 240. By selecting the menu 240, the employee can view the window 241 described previously. As previously described the window 241 includes options for actions that can be taken with regards to the items in the selected bag. For example, the employee can choose between “Remove from hold,” “Put back to hold,” and “Transfer hold.” To return the items in the order to their respective cold storage hold location(s), the employee can select the option “Put back to hold.” The employee can then place the items in their indicated hold location(s). As a result of this selection, the associated order presented in the user interface 120 of FIG. 3A can be updated such that the order is no longer depicted in the yellow highlighting/yellow box indicia.

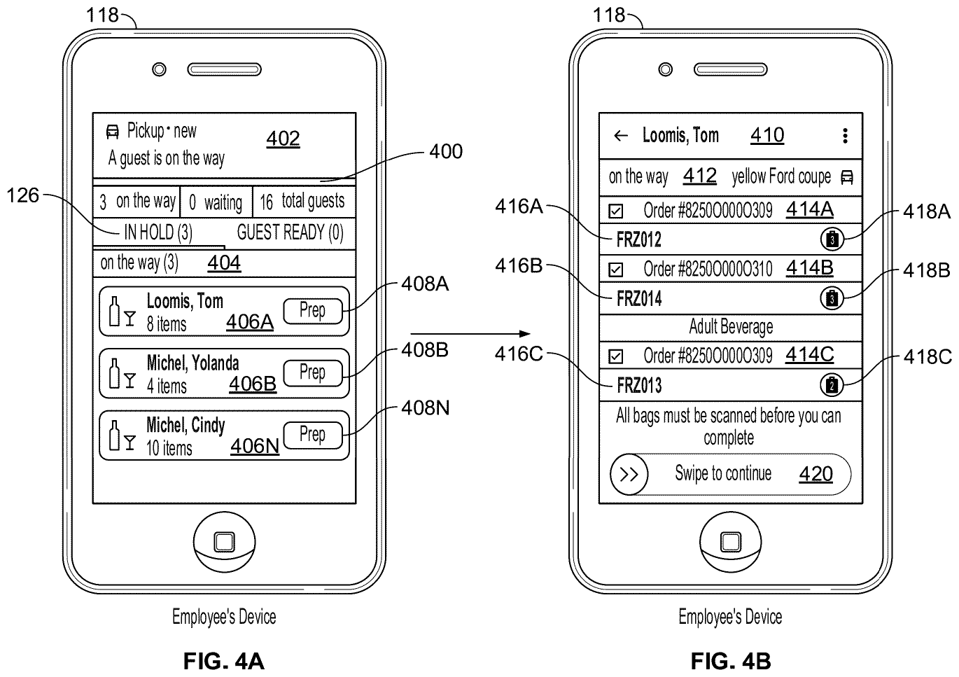

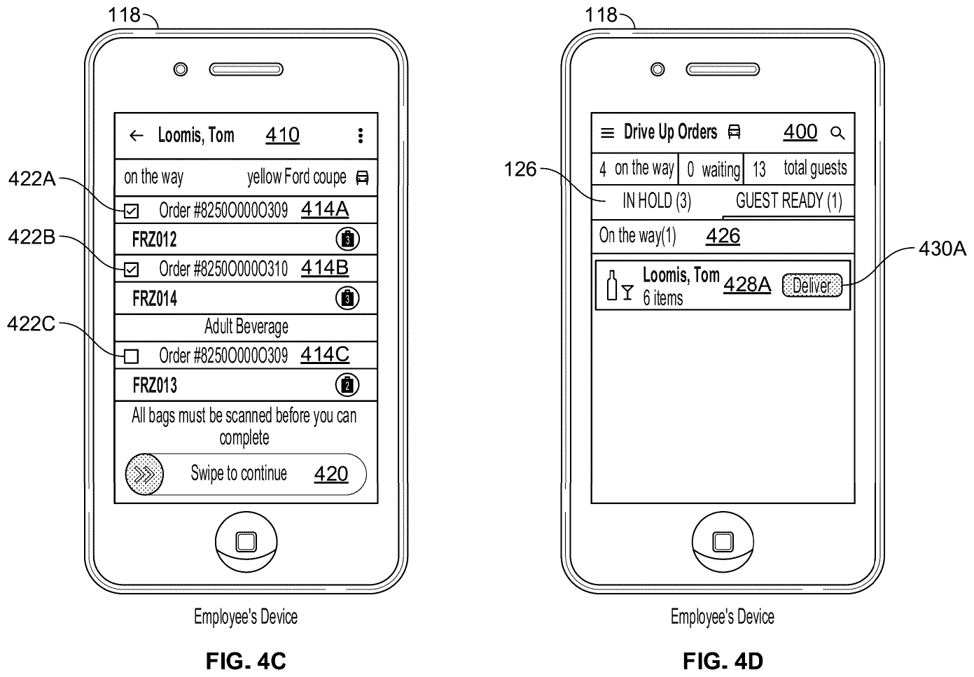

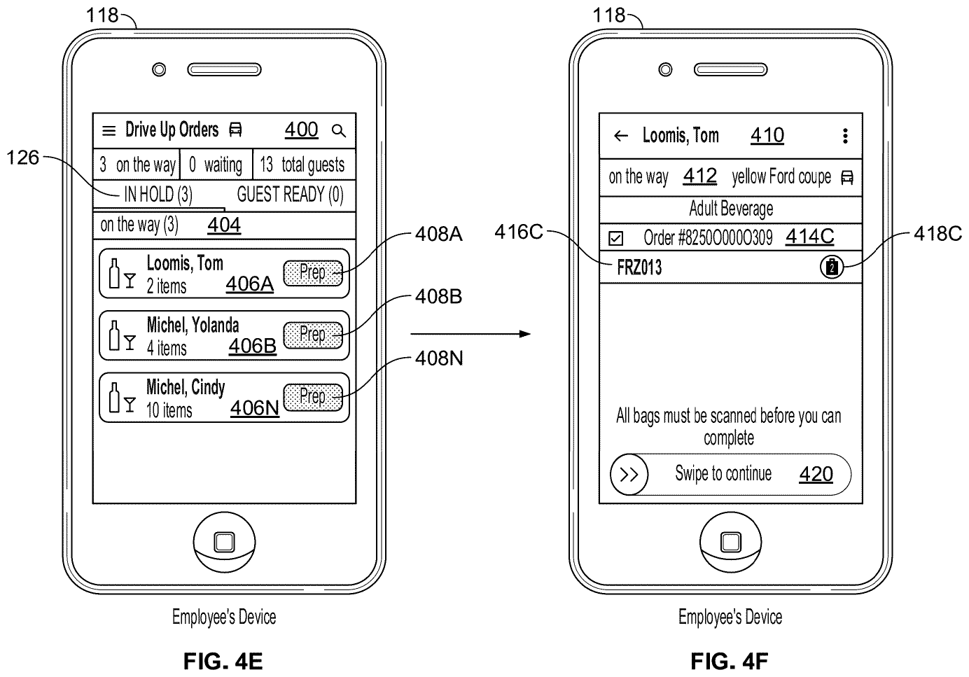

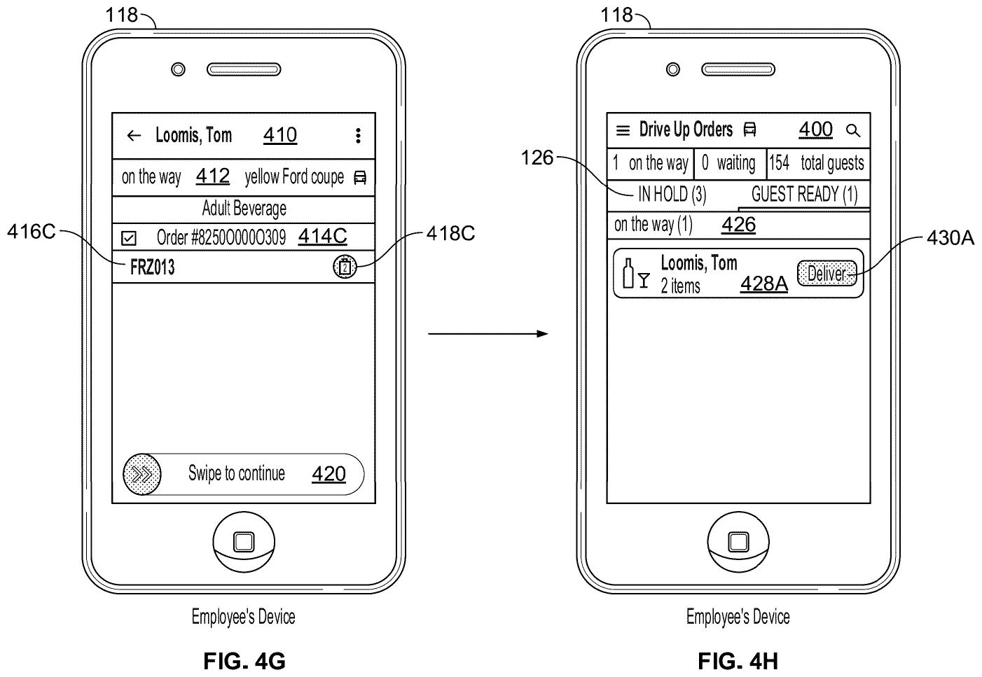

FIGS. 4A-I show example user interface displays for preparing and delivering partial orders. As described herein, some orders can contain both alcoholic beverages or other adult beverages and grocery items or non-alcoholic (e.g., non-adult) beverages. An order having a combination of such items may require the alcoholic beverages to be delivered separately from the grocery items. For example, the alcoholic beverages may be delivered separately from the grocery items if a customer arrives for order pickup outside of sellable hours for alcoholic beverages (which can vary based on state or other local jurisdiction). The alcoholic beverages may be cancelled from the order and the customer may only receive a partial order containing the grocery items. As another example, the alcoholic beverages may be delivered separately from the grocery items if the customer is underage or arrives without their government-issued ID. The alcoholic beverages may be cancelled from the order, the customer may be required to return to the fulfillment location with their government-issued ID to pick up the alcoholic beverages at another time, and/or the customer may be required to enter the fulfillment location and present their ID/proof of age to an employee in the fulfillment location. One or more other special actions may also be performed based on the order containing a mix of special items as described throughout this disclosure.

Although FIGS. 4A-I are described in reference to orders having alcoholic beverages and grocery items, these techniques can also be applied to orders having other combinations of items that may require a portion of those items to be delivered separately from another portion of those items. For example, the techniques described in FIGS. 4A-I can be applied to orders having medications or other pharmaceuticals, other adult beverages, tobacco products, other age-restricted products, certain electronics, items of certain sizes/dimensions/weights, items of certain prices, etc.

Referring to the FIGS. 4A-I, FIG. 4A depicts a user interface 400 for displaying orders pending in an “In Hold” tab. The user interface 400 is similar or the same as the user interface 120 described throughout this disclosure (refer to FIG. 2A for additional discussion about the user interface 120). The user interface 400 can include the panel 126 with selectable options to navigate between tabs for “In Hold” orders and “Guest Ready” orders. Here, an employee of the computing device 118 has selected “In Hold” in the panel 126, which caused an “On the way” panel 404 to be presented in the user interface 400. The “On the way” panel 404 is similar or same as the panel 126 described throughout this disclosure.

The panel 404 includes 3 orders, 406A, 406B, and 406N. Each of the orders 406A-N include alcoholic beverages (e.g., adult beverages), as visually indicated by graphical elements depicting wine bottles and martini glasses with each of the orders 406A-N (refer to FIG. 2A for additional discussion about the graphical elements, which are quick reference visual icons of items that make up an order). Each of the orders 406A-N also include respective selectable controls 408A-N. Each of the controls 408A-N indicate “Prep.” The controls 408A-N are similar or same as the control 138 described throughout this disclosure.

The user interface 400 can also include a notification 402, which can appear over a portion of the user interface 400. The notification 402 can appear over a top portion of the user interface 400 and can overlay a portion of information presented in the user interface 400. The notification 402 can appear for a predetermined amount of time (e.g., 3-5 seconds) before disappearing from the user interface 400. In some implementations, the notification 402 may not disappear until the employee of the computing device 118 clicks on the notification 402, swipes up on the notification 402, and/or dismisses the notification 402 (e.g., by selecting an icon in the notification 402 to close out of it, such as an “x”). The notification 402 can indicate information about customers that are on their way and/or arriving at the fulfillment location. The notification 402 can appear, and then the panel 404 can be updated with another order that corresponds to the customer presented in the notification 402. For example, if John Smith is on his way to the fulfillment location, the notification 402 can be presented at the computing device 118 and can indicate that John Smith is on his way. The panel 404 can be automatically updated to include an order associated with John Smith, that order being available for preparation by the employee or another employee. As another example, if customer Tom Loomis, associated with the order 406A, has arrived at the fulfillment location, the notification 402 can be presented and can indicate that Tom Loomis has arrived. The panel 404 can then be automatically updated by removing the order 406A from the panel 404 and adding the order 406A to a new panel for “Arrived” orders. Refer to FIG. 2A for additional discussion about the “Arrived” panel. In some implementations, the notification 402 may simply indicate that a customer is on their way to the fulfillment location, instead of indicating which customer is on their way to the fulfillment location. The notification 402 can therefore be used by the employee of the computing device 118 to gauge how they should spend their time preparing and/or delivering orders in an efficient and effective way.

Still referring to FIG. 4A, the employee of the computing device 118 can select any of the controls 408A-N to claim a task of preparing the respective order 406A-N. Here, the employee has selected the control 408A to prepare the order 406A for customer Tom Loomis. Selecting the control 408A can cause a new user interface to be presented at the computing device 118, as shown and described in FIG. 4B. In some implementations, each of the orders 406A-N can be made up of multiple orders corresponding to the particular customer. The orders 406A-N can include any orders that have been placed by the particular customer but not yet prepared and/or delivered to the particular customer. For example, the order 406A can be made up of 3 separate orders that the customer Tom Loomis had placed (refer to FIG. 4B). The 3 orders can be placed by Tom Loomis at a same time. The 3 orders can also be placed by Tom Loomis at various different times. As mentioned above, the 3 orders may not yet have been prepared and/or delivered to Tom Loomis.

FIG. 4B depicts a user interface 410 for preparing an order. As mentioned in reference to FIG. 4A, the employee has selected the control to prepare the order for Tom Loomis. The user interface 410 presents information about Tom Loomis's order. For example, the user interface includes a field 412, which provides information about Tom's arrival to the fulfillment location. The field 412, for example, can indicate whether the customer has arrived, is waiting, or is on their way to the fulfillment location. The field 412 can also provide identifying information for the customer's vehicle. The field can be similar or same as the field 230 described in reference to FIGS. 2A-Y.

The user interface 410 also includes fields 414A, 414B, and 414C, indicating first, second, and third orders (or sub-orders) for the customer, Tom Loomis. Each customer can have a different quantity of orders, as described throughout this disclosure. The orders can also be placed at different times and presented in the user interface 410. The orders can also be placed at same or similar times and presented in the user interface 410 as a single order or as multiple orders. The fields 414A, 414B, and 414C are similar or same as the field 226A and other similar fields described throughout this disclosure (e.g., refer to description of the field 226A in FIGS. 2A-Y). The fields 414A, 414B, and 414C can indicate sub-orders or portions of an order that make up the entire order for the customer. Thus, in the example of FIG. 4B, Tom Loomis's entire order is made up of 3 sub-orders, where each sub-order contains items in different hold locations.

Moreover, the field 414C includes a banner indicating “Adult Beverages.” This banner can provide a visual indication to the employee preparing the order that special action(s) may be required in order to complete this order since the order includes the adult beverage(s). The indication in the banner can vary depending on what type of items are part of the order. For example, an order including medications can include a banner indicating “Medications.” An order including frozen items can include a banner indicating “Frozen items.” As another example, an order including a cellphone or other type of electronic can include a banner indicating “Electronics.” One or more other banners can be generated and presented in the user interface 410 with one or more of the orders (or sub-orders) to assist the employee in categorizing the orders and identifying/determining whether special actions may be required for handling (e.g., preparing and/or delivering) the order(s).

Each field 414A, 414B, and 414C includes sub-fields 416A, 416B, and 416C, respectively. The sub-fields 416A, 416B, and 416C can indicate hold locations of items for the order associated with the respective field 414A, 414B, and 414C. The sub-fields 416A, 416B, and 416C are similar or same as the sub-field 232A and other similar sub-fields described throughout this disclosure (e.g., refer to description of the sub-field 232A in FIGS. 2A-Y). In the example of FIG. 4B, the sub-order associated with field 414A includes items that are held in a location called “FRZ012,” as indicated by the sub-field 416A. This location can be a particular freezer or refrigerated section. The sub-order associated with the field 414B includes items that are held in a location called “FRZ014,” as indicated by the sub-field 416B. The location can be a different freezer or refrigerated section. The sub-order associated with the field 414C includes items that are held in a location called “FRZ013,” as indicated by the sub-field 416B. This location can be another different freezer or refrigerated section.

Additionally, each of the sub-fields 416A, 416B, and 416C can include respective indicators 418A, 418B, and 418C for bags (and items per bag) that are at the indicated locations. The indicators 418A, 418B, and 418C can be similar or same as the indicator 234A and similar indicators described throughout this disclosure (e.g., refer to the description of the indicator 234A in FIGS. 2A-Y). Finally, the user interface 410 can include selectable option 420 to complete preparation of the orders represented by the fields 414A, 414B, and 414C. The selectable option 420 can be similar or same as the selectable option 208 described throughout this disclosure (e.g., refer to description of the selectable option 208 in FIGS. 2A-Y).

As mentioned above, when the employee selects Tom Loomis's order from the user interface 400 described in FIG. 4A, the user interface 410 can be presented at the employee's computing device 118. Here, the employee can select or deselect any of the orders represented by the fields 414A, 414B, and 414C during order preparation. For example, the employee may only select the orders represented by the fields 414A, 414B, and 414C that the employee wishes to deliver to the customer upon their arrival. Hence, the employee can prepare and deliver a partial order to the customer. Refer to FIG. 4C for additional discussion about preparing the partial order.

FIG. 4C depicts the user interface 410 when the employee selects only a portion of the orders represented by the fields 414A, 414B, 414C. Each of the fields 414A, 414B, and 414C include a respective checkbox 422A, 422B, and 422C. All of the checkboxes 422A, 422B, and 422C can be selected as a default, as shown in FIG. 4B, to ensure that the employee prepares all sub-orders of the customer's entire order. Here, however, the employee has selected the checkboxes 422A and 422B for the orders represented by the respective fields 414A and 414B. The employee has deselected the checkbox 422C for the order having the adult beverages, as represented by the field 414C. By making this deselection, the employee has shown their intent to not prepare and deliver the portion of Tom Loomis's order that contains the adult beverages. The employee can make this deselection when Tom Loomis arrives outside of sellable hours of alcoholic beverages.

As a result of the employee's interactions with the checkboxes 422A, 422B, and 422C, the employee may now scan all of the bags out of their respective hold locations that are associated with the selected checkboxes 422A and 422B. In other words, the employee can prepare a partial order that includes bags of items for the orders represented by the fields 414A and 414B. Once the employee scans these bags out of their respective hold locations as described above in reference to FIGS. 2A-Y, the option 420 can become selectable. As described herein, the employee can swipe across the option 420 to complete preparation of this partial order. Once preparation is complete, other user interfaces can be updated and presented to the employee as described further below in reference to FIG. 4D.

FIG. 4D depicts the user interface 400 when orders are ready to be delivered to customers. The employee has selected the “Guest Ready” tab from the panel 126, which causes panel 426 to be populated with orders, and/or partial orders, that have been prepared by employees at the fulfillment location and are ready to be delivered to customers upon their arrival. The panel 426 is same or similar as the panel 132 described throughout the FIGS. 2A-Y. In the example of FIG. 4D, only one customer order 428A has been prepared, which is Tom Loomis's partial order as described in FIGS. 4A-C. The order 428A also includes a selectable control 430A, indicating “Deliver.” Any employee at the subset of computing devices 118 can select the control 430A to claim the task of delivering Tom Loomis's prepared order, or, in this case, Tom Loomis's partial order (which is 6 of the 8 items that Tom Loomis had ordered). The control 430A is similar or same as the control 220N described in FIG. 2D. Refer to the description in FIG. 2D for additional discussion about claiming the task of delivering an order.

Selecting the control 430A can cause another user interface to be displayed at the employee's computing device. The user interface can be similar or same as the user interface 224 described in reference to FIGS. 2F-H, which includes information about the selected order. As described in reference to FIGS. 2F-H, if the employee who selected the control 430A to deliver the order also prepared the order, the indicators of the bags in the user interface can be shown as already scanned out (e.g., refer to FIG. 2H). If a different employee selected the control 430A to deliver the order, then the employee must unselect a portion of the order that they will not be delivering to the guest and then scan all the remaining bags associated with the portion of the order that the employee will be delivering. Refer to FIG. 4C for additional discussion about only scanning a portion of the order. Once all the bags have been scanned by the employee for the portion of the order that is selected for delivery, an option, such as the option 420 in FIG. 4C, can be selectable. The employee can select the option by sliding or swiping the option to the right side of the user interface (e.g., refer to FIGS. 2H and 4C).

Then, as described herein, the employee can take the portion of the order that has been scanned out to the customer's vehicle upon their arrival. The employee can ensure that the customer knows the other portion of their order (e.g., in Tom Loomis's case, the other portion includes the adult beverages) is not being delivered to their vehicle and that the other portion is in hold pending pickup until a hold window expires. The hold window can be different per fulfillment location. The hold window can also vary depending on a type of the item or items in hold. For example, the hold window can be 5 days for any items in a particular fulfillment location. As another example, the hold window can be 3 days for grocery items and 7 days for adult beverages. One or more other hold windows can also be used for the fulfillment location.

As described throughout this disclosure, employees can unselect bags and/or orders (or sub-orders) in the user interface 410 during prep and/or delivery processes. If, for example, an employee unselects a bag or a sub-order during prep (e.g., refer to FIG. 4C) and that same employee is also delivering the order, then the user interface 410 can remain updated during the delivery process to reflect which bag or sub-order remains unselected. If a different employee delivers the order, then the different employee may need to unselect the bag or sub-order that they do not want to process in the delivery, even if the other employee scanned that bag and/or sub-order out of hold during the prep process. Therefore, unselecting a bag and/or sub-order may not transfer across all computing devices 118 in the subset of computing devices 118 when one employee does the prep process and another employee does the delivery process. In some implementations, however, unselecting the bag and/or sub-order during the prep process can be transferred across all computing devices 118 in the subset of computing devices 118 such that all employees can become aware, in real time or in near real time, of partial orders.

FIG. 4E depicts the user interface 400 for preparing the remainder of an order that has been partially prepared and delivered. The employee of the computing device 118 can navigate to the “In Hold” tab in the panel 126. The “On the way” panel 404 can include orders 406A-N which have yet to be prepared. Here, the orders 406B and 406N are the same as in FIG. 4A— neither of these orders have been prepared yet and each order still contains the same number of items as when the orders first appeared in the panel 404 (e.g., refer to FIG. 4A). The only order that has changed is the order 406A, which is Tom Loomis's order. As shown in FIG. 4A, the order 406A contained 8 items. However, as shown in FIGS. 4B-D, Tom Loomis's order was partially prepared and delivered such that 6 non-adult beverage items were delivered to the customer and only 2 items, adult beverages, remain in the order 406A to be prepared and delivered to the customer Tom Loomis. Therefore, the order 406A in FIG. 4E now reflects that Tom Loomis's order still needs to be prepared but that it only includes 2 items instead of 8. The employee can select the control 408A to view additional information about the order 406A and to claim the task of preparing this order. The additional information can be presented in the user interface 410, described in FIG. 4F.

FIG. 4F depicts the user interface 410 for preparing the remainder of an order. Here, since the other portions of Tom Loomis's order have been prepared (and potentially delivered), the user interface 410 only depicts the remaining order, or sub-order, to be prepared. Therefore, the user interface 410 only presents the field 414C with the banner “Adult Beverage” in comparison to presenting the fields 414A, 414B, and 414C as described in FIG. 4B.

The employee can go to the hold location “FRZ013,” as represented by the sub-field 416C, and scan out of hold a bag having 2 items at that location, as represented by the indicator 418C. Once all bags associated with the remainder of Tom Loomis's order have been scanned out of hold by the employee, the user interface 410 can be updated, as shown in FIG. 4G.

FIG. 4G depicts the user interface 410 once all bags associated with the remainder of an order have been scanned out of their respective hold location(s). The indicator 418C can change indicia, as described in reference to FIGS. 2A-Y, from a black bag to a green bag. The green bag can indicate that the bag has been scanned out of its hold location with all the items contained therein. The option 420 can then become selectable on the user interface 410. The employee can swipe across the option 420, as described throughout this disclosure, to then complete the task of preparing the remainder of Tom Loomis's order.

FIG. 4H depicts the user interface 400 when partial orders are ready to be delivered to customers. The employee has selected the “Guest Ready” tab from the panel 126, which causes the panel 426 to be populated with orders, including partial orders, that have been prepared by employees at the fulfillment location and are ready to be delivered to customers upon their arrival. Here, because the employee prepared the remainder of Tom Loomis's order (refer to FIGS. 4G-H), the remainder of Tom Loomis's order appears as order 428A with the selectable control 430A in the panel 426. Therefore, any employee of the subset of computing devices 118 can select the control 430A to claim the task of delivering the remainder of Tom Loomis's order (which includes the 2 adult beverages) upon Tom Loomis's arrival at the fulfillment location.

As described in reference to FIG. 4D, if the same employee who prepared the remainder of Tom Loomis's order also selects the control 430A to deliver the remainder of the order, then the user interface 410 can be presented at the employee's computing device 118 with all the associated bags already shown as being scanned out of their respective hold location(s). If, on the other hand, a different employee claims the delivery task for the remainder of Tom Loomis's order, then the employee may be required to scan all the associated bags out of their hold location(s) before delivery. Refer to FIG. 4D for additional discussion. Once all the bags are scanned out of their hold locations, the employee can take the bag(s) out to the customer's vehicle for delivery.

FIG. 4I depicts a user interface 432 for verifying the customer can pick up the remainder of the order. The user interface 432 can be presented at the employee's computing device 118 once the user selects an option, such as option 420, to continue to delivery after scanning all bags out of their hold location(s). The user interface 432 can present one or more checks for the employee to verify the customer's identity and/or age. If the remainder of the order contains adult beverages, for example, the user interface 432 may automatically pop up on the computing device 118 once the employee enters a guest or other customer code at the customer's vehicle. The delivery may not be completed until the employee fills in and verifies information in the user interface 432.

The user interface 432 can prompt the employee to check the customer's government-issued ID and enter their date of birth into the user interface 432. If a date of birth is entered that is over the legal age to purchase/consume adult beverages in the jurisdiction of that fulfillment location, then delivery of the remainder of the order can be marked as completed. A notification can appear in the user interface 432 indicating the entered date of birth and a green check symbol to show that the date of birth is valid. If the date of birth entered does not satisfy the legal age requirement(s) of that jurisdiction, an alert can appear on the user interface, such as a hazard symbol and/or triangle with an exclamation point therein. The alert can include the date of birth that was entered. Optionally, the alert can also include some indication that the customer is underage and that the remainder of the order cannot be delivered to the customer. For example, the alert can indicate, “Guest must be 21 or older to complete this order.” One or more other indications can also be included in the alert. The employee may, in such scenarios, have to cancel the remainder of the order and return the items for the remainder of the order to their respective hold locations or other locations/storage areas in the fulfillment location.

The user interface 432 can present one or more other checks to be performed by the employee before completing delivery of the remainder of the order. In some implementations, the checks can vary depending on the type of items in the remainder of the order. In some implementations, the checks can also vary depending on local laws, regulations, and/or policies of the fulfillment location. The user interface 432 can also be presented at the computing device 118 while processing any order that contains at least one age-restricted item.

As an illustrative example, the user interface 432 can include an option to scan the customer's license or other government-issued ID. The employee can use a magnetic strip and/or optical code scanner, which can be part of the computing device 118 or separate from the computing device 118. The scanner can also be in communication (e.g., wired and/or wireless) with the computing device 118. In some implementations, the user interface 432 can present an option to collect biometric data associated with the customer. The biometric data can be previously collected and stored and thus retrieved during the delivery process. For example, during past deliveries, the customer may have provided a thumbprint or other biometric scan with express permission to use that data to facilitate quicker and more efficient checkout in the future. This data can include or otherwise be linked to age information about the customer, which can be used to verify that the customer can receive the remainder of the order. This data can therefore be used for completing delivery of entire orders, partial orders, orders with no adult beverages, orders with adult beverages, etc.

As another example, the user interface 432 can include an option to scan a prescription if the remainder of the order includes medications or other similar types of items. The user interface 432 can also include an option to input an RX number, a prescription ID or confirmation code, and/or the customer's date of birth/patient information in order to verify that the customer can pick up the remainder of the order/is authorized to pick up the remainder of the order.

As yet another example, in some implementations, the customer can verify their identity and/or age before arriving at the fulfillment location to provide a quick and efficient delivery process. When the customer places an order containing the age-restricted items, such as alcoholic beverages, the customer can be required to scan their license or other government-issued ID to complete checkout. As part of completing the checkout process, the customer's age can therefore be verified by analyzing the scanned ID (e.g., which can be performed by the server system 116 described in FIG. 1). If the customer's age is verified, once the customer arrives to pick up their order and the employee goes to input the customer code for completing delivery of the order, the customer code can be linked to a notification that the customer's age is verified and that they can pick up the order. Therefore, the user interface 432 may not be presented at the computing device 118 and the employee may not have to perform additional verification steps as described above. The delivery can be completed quickly and efficiently. In some implementations, for example when the scanned ID cannot be accurately analyzed during the online checkout process, the user interface 432 can be presented at the computing device 118 and the employee can be prompted to perform additional verification steps before completing the delivery.

One or more other age and/or identity validation techniques can be presented at the user interface 432 before the remainder of the order can be delivered. For example, in some implementations, the user interface 432 may present only one validation check while in other implementations, the user interface 432 may present more than one validation check. As another example, the customer may be required to provide proof of their age at a time of placing an order for age-restricted items (e.g., inputting their birthday in a GUI at the customer's user device). At time of delivery, the employee can ask the customer for their government-issued ID and compare the birthday on the ID to the birthday that the customer had inputted during the ordering process. If the birthdays match, the employee can complete delivery of the age-restricted items. If the birthdays do not match, the employee may not complete the delivery. Instead, the employee may return the age-restricted items to their designated locations in the store and cancel the order (or cancel the partial order containing the age-restricted items).

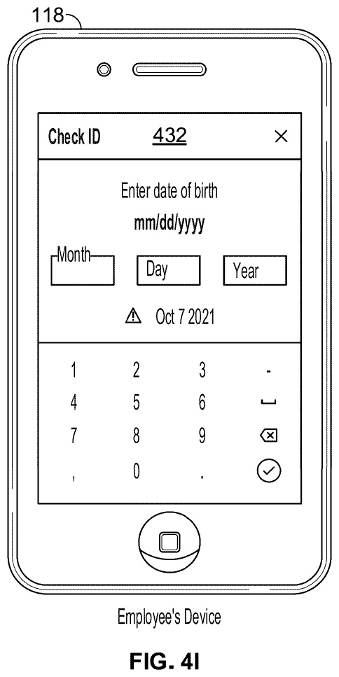

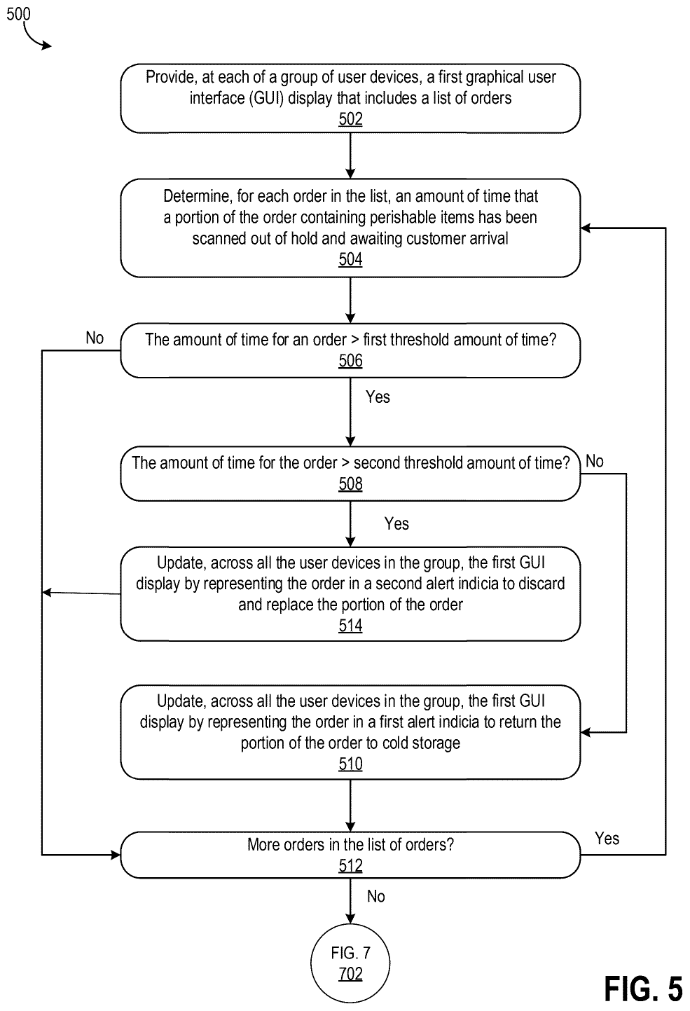

FIG. 5 is a flowchart of a process 500 to be performed by one or more computing devices in a drive-up fulfillment system when an order for a drive-up customer includes perishable items. The process 500 can be performed to put items, such as the perishable items, back in cold storage hold locations. An employee may be required to put the perishable items back in the cold storage hold locations if the perishable items have been out in a room temperature location for longer than a threshold amount of time, as described herein.

The process 500 can be performed by the server system 116 depicted and described in reference to FIG. 1. The process 500 can also be performed by any of the computing devices 118 of employees in the fulfillment location. The process 500 can also be performed by one or more other computing systems, devices, computers, networks, cloud-based systems, and/or cloud-based services. For illustrative purposes, the process 500 is described from the perspective of a server.

Referring to the process 500 in FIG. 5, the server can provide, at each of a group of user devices, a first graphical user interface (GUI) display that includes a list of orders (block 502). For example, the server can provide, to each of the user devices in the group (e.g., the computing devices 118), information that, when processed by each of the user devices, causes each of the user devices to display the first GUI including the list of orders for customers for fulfillment at a fulfillment location. Refer to FIG. 2A for additional discussion about the first GUI.

The server can determine, for each order in the list, an amount of time that a portion of the order containing perishable items has been scanned out of hold and awaiting customer arrival (block 504). The server can also determine how much time the order has been scanned out of hold, regardless of whether the order contains perishable items. As described throughout this disclosure, the perishable items can include grocery items such as dairy products, vegetables, fruits, fresh produce, meats, seafood, certain beverages/drinks, and frozen items. The perishable items can include any type of item that may be refrigerated or kept in a freezer. Moreover, as described herein, the amount of time can begin once the perishable items are scanned out of their respective cold storage hold locations during an order preparation process. Refer to FIGS. 3A-B for additional discussion.

The server can determine whether the amount of time for an order exceeds a first threshold amount of time in block 506. As described herein, the first threshold amount of time can be an amount of time that the perishable items in the order can remain in a room temperature hold location before being returned to their respective cold storage hold locations. When the perishable items are scanned out of their hold locations, they can be placed in the room temperature hold location until the customer arrives and the items can be delivered to the customer. However, if the perishable items remain in the room temperature hold location for longer than the first threshold amount of time, the perishable items can spoil or decrease in quality. In some implementations, determining whether the amount of time for the order exceeds the first threshold amount of time can include determining whether the order contains at least one item having a refrigerated hold location or a frozen hold location. If the order does not contain an item having either the refrigerated or frozen hold location, then process 500 can be stopped. Therefore, the process 500 may be performed, in some implementations, only for orders having items that should remain in cold storage to preserve their quality and safety for consumption.

As described herein, the first threshold amount of time can vary depending on the type of perishable items. In some implementations, the first threshold amount of time can be the same for all refrigerated items and/or all frozen items. As an example, the first threshold amount of time can be 10 minutes for all perishable items. Refer to FIG. 3A for additional discussion. In some implementations, the first threshold amount of time can be longer for items having the refrigerated hold location than items having the frozen hold location. In some implementations, the first threshold amount of time can be longer for items having the frozen hold location than items having the refrigerated hold location. In yet some implementations, the first threshold amount of time can be longer for the order than other orders in the list of orders based on a determination, by the server, that the order contains at least one item that is part of a first threshold category of items. The first threshold category of items can be a produce category (e.g., fruit, vegetables, etc.). The first threshold category can be a non-perishable goods category (e.g., bread, canned items, some frozen items, boxed or packaged items, items that may not spoil within some amount of time from being stored at room temperature, electronics, medications, household supplies, pet supplies, etc.). The first threshold category can include any type of items that may not spoil or lower in quality within some amount of time of being stored at room temperature. Sometimes, the first threshold amount of time can be shorter for the order than other orders in the list of orders based on a determination, by the server, that the order contains at least one item that is part of a second threshold category of items. The second threshold category of items can be a frozen goods category. The second threshold category of items can also be a refrigerated goods category. The second threshold category can include fresh produce. In some implementations, the second threshold category can include meat or fish products. The second threshold category can include any type of items that may spoil or lower in quality within some amount of time of being stored at room temperature.

If the amount of time for the order does not exceed the first threshold amount of time, the server can proceed to block 512, discussed below. In other words, the perishable items for the order have not been out in the room temperature hold location for long enough to warrant putting those items back in their respective cold storage hold locations. These items may not have to be put back in their respective cold storage hold locations if the customer arrives within the first threshold amount of time. If the customer, however, is delayed and arrived after the first threshold amount of time, then the perishable items may have to be returned to their respective cold storage hold locations.

If the amount of time for the order exceeds the first threshold amount of time in block 506, then the server can determine whether the amount of time for the order exceeds a second threshold amount of time in block 508. The second threshold amount of time, as described herein, can indicate an amount of time that the perishable items have been out in room temperature and not returned to their respective cold storage locations. The second threshold amount of time can be greater than the first threshold amount of time. For example, the first threshold amount of time can be 10 minutes and the second threshold amount of time can be 15 minutes. In some implementations, the second threshold amount of time can be shorter than the first threshold amount of time. The second threshold amount of time can also begin counting once the first threshold amount of time is passed. For example, if the first threshold amount of time is 10 minutes, once the perishable items are out in room temperature for the first threshold amount of time, an amount of time that the perishable items remain in room temperature past the first threshold amount of time can be counted and compared to the second threshold amount of time. In this example, the second threshold amount of time can be 5 minutes past the first threshold amount of time. If the perishable items remain in room temperature for more than the second threshold amount of time, then the employees at the group of user devices can be alerted to discard, replace, and/or cancel those perishable items in the order. After all, the perishable items may spoil or lower in quality if left out for more than the second threshold amount of time. Refer to FIG. 3B for additional discussion.

If the amount of time for the order does not exceed the second threshold amount of time, then the server can update, across all the user devices in the group, the first GUI display by representing the order in a first alert indicia to return the portion of the order to cold storage (block 510). For example, the server can provide, to at least a subset of the group of user devices and based on a determination that the amount of time for the order exceeds the first threshold amount of time but not the second threshold amount of time, instructions to update the first GUI such that the order is represented in the first indicia. The first alert indicia can be yellow highlighting. Refer to FIG. 3A for additional discussion about the first alert indicia. The first alert indicia can be used to notify the employees at the group of user devices that there are perishable items in the order that should be returned to their respective cold storage locations because they have been out in room temperature for over the first threshold amount of time (e.g., 10 minutes, in some implementations).

Moreover, in some implementations, block 510 can be performed before block 508. For example, the server can determine that the amount of time for the order exceeds the first threshold amount of time in block 506 and then perform block 510 in which the order is presented in the first alert indicia. Once block 510 is performed, the server can determine whether the amount of time for the order exceeds the second threshold amount of time in block 508. For example, the server can determine whether the order has been returned to its respective cold storage hold location within the second threshold amount of time from being scanned out of that hold location. The server can then provide, to at least a subset of the group of user devices and based on a determination that the order has not been returned within the second threshold amount of time to its respective cold storage hold location, instructions to update the first GUI such that the order is represented in a second alert indicia, described below.

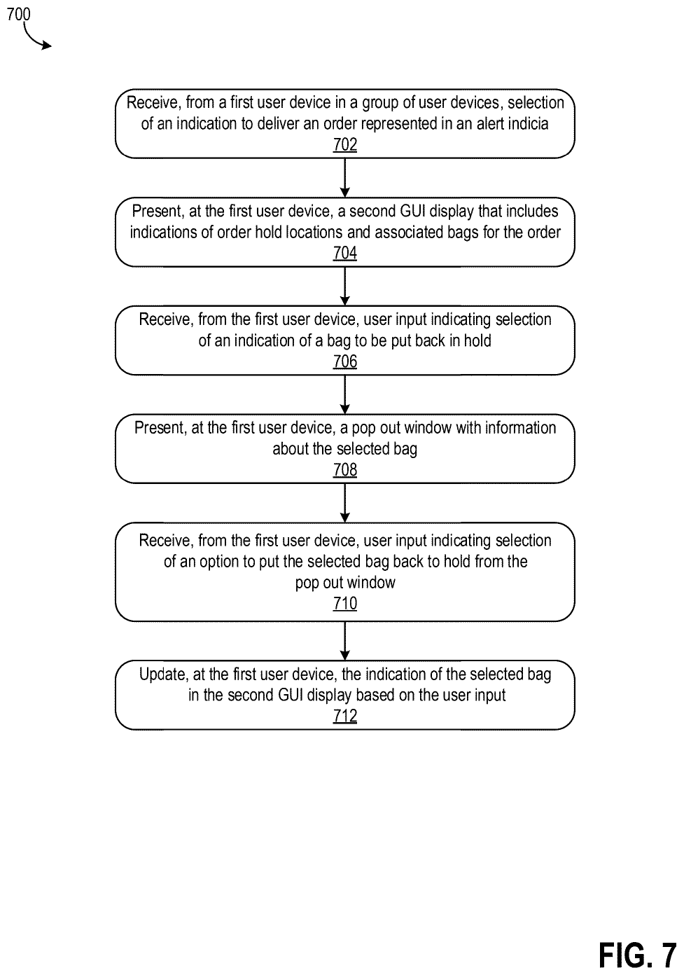

After performing block 510, the server can proceed to block 512, in which the server determines whether more orders are in the list of orders. If there are more orders in the list, the server can return to block 504 and repeat blocks 506-510 for each remaining order. If there are no more orders in the list, the process 500 can stop and/or the server can proceed to block 702 in process 700 described in FIG. 7.

Referring back to block 508, if the amount of time for the order exceeds the second threshold amount of time, then the server can update, across all the user devices in the group, the first GUI display by representing the order in a second alert indicia to discard and replace the portion of the order (block 514). The second alert indicia can be red highlighting. The second alert indicia can be used to notify the employees of the group of user devices that the order contains perishable items that have been left out in room temperature for too long and thus should be discarded, replaced, and/or cancelled from the order. After all, the perishable items might have been left out for longer than the second threshold amount of time, thereby risking quality and/or safety of the perishable items. To ensure positive customer experience, such perishable items should be discarded, replaced, and/or cancelled. Returning the perishable items to their respective cold storage hold locations at this time may not be sufficient to ensure quality and safety of those items. Refer to FIG. 3B for additional discussion. The server can then proceed to block 512, described above.

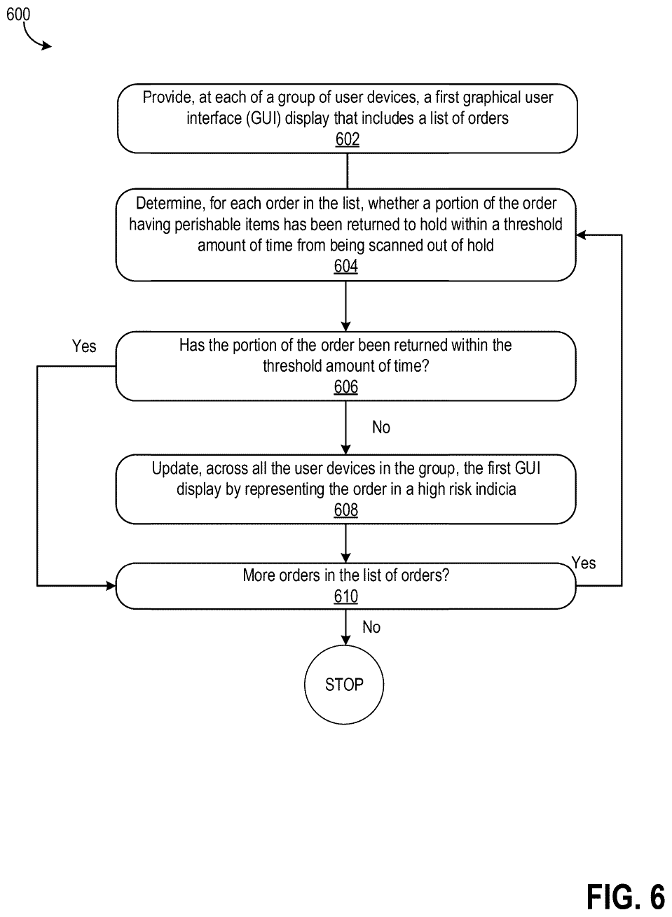

FIG. 6 is a flowchart of another process 600 to be performed by one or more computing devices in a drive-up fulfillment system when an order for a drive-up customer includes perishable items. The process 600 can be performed when action needs to be taken on an order that has not been returned to its respective cold storage hold location. For example, the process 600 can be performed as part of blocks 508 and 514 in the process 500 of FIG. 5.

The process 600 can be performed by the server system 116 depicted and described in reference to FIG. 1. The process 600 can also be performed by any of the computing devices 118 of employees in the fulfillment location. The process 600 can also be performed by one or more other computing systems, devices, computers, networks, cloud-based systems, and/or cloud-based services. For illustrative purposes, the process 600 is described from the perspective of a server.

Referring to the process 600, the server can provide, at each of a group of user devices, a first GUI display that includes a list of orders (block 602). Refer to block 502 in the process 500 of FIG. 5 for additional discussion.

The server can determine, for each order in the list, whether a portion of the order having perishable items has been returned to hold within a threshold amount of time from being scanned out of hold in block 604. For example, as described in the process 500 in FIG. 5, the order can be presented in the first alert indicia (block 510) when the order has been out in room temperature for longer than the first threshold amount of time. In block 604, the server can determine whether the order has been returned to its respective cold storage hold location since the order was presented in the first alert indicia, thereby notifying the employees of the group of user devices to take action on this order. The threshold amount of time from being scanned out of hold can be the second threshold amount of time described in the process 500 in FIG. 5 (block 508). For example, the threshold amount of time in block 604 can be 15 minutes. The server can determine in block 604 whether the order has been returned to its cold storage hold location within 15 minutes since being scanned out of that hold location.

In block 606, the server can confirm whether the portion of the order (or the entire order, in some implementations) has been returned to its respective cold storage hold location within the threshold amount of time. In some implementations, block 606 can be part of or otherwise performed as part of block 604.

If the portion of the order has been returned to its respective cold storage hold location, the server can proceed to block 610. In block 610, the server can determine whether there are more orders in the list of orders to check. If there are more orders, the server can return to block 604 and repeat blocks 604-608 for the remaining orders in the list. If there are no more orders to check in block 610, the process 600 can stop.

Referring back to block 606, if the portion of the order has not been returned to its respective cold storage hold location within the threshold amount of time, the server can update, across all the user devices in the group (or a subset or portion of the user devices in the group), the first GUI display by representing the order in a high risk indicia (block 608). The high risk indicia can be the same as the second alert indicia described in block 514 of the process 500 in FIG. 5. The high risk indicia, as further described in reference to FIG. 3B, can alert the employees of the user devices in the group when items in the order need to be discarded, replaced, and/or cancelled for surpassing a food quality and safety risk tolerance level of the fulfillment location.

FIG. 7 is a flowchart of a process 700 to be performed by one or more computing devices in a drive-up fulfillment system when an employee puts a portion of an order for a drive-up customer back in a hold location. In some implementations, the process 700 can be performed after block 512 in the process 500 in FIG. 5. In some implementations, the process 700 can be performed whenever the employee puts the portion of the order back in the respective hold location (e.g., cold storage hold location).

The process 700 can be performed by the server system 116 depicted and described in reference to FIG. 1. The process 700 can also be performed by any of the computing devices 118 of employees in the fulfillment location. The process 700 can also be performed by one or more other computing systems, devices, computers, networks, cloud-based systems, and/or cloud-based services. For illustrative purposes, the process 700 is described from the perspective of a server.

Referring to the process 700 in FIG. 7, the server can receive, from a first user in a group of user devices, selection of an indication to deliver an order represented in an alert indicia (block 702). For example, the server can receive, from the first user device of the group of user devices, an indication of user selection of a first control presented in the first GUI indicating an intention to deliver an order in the list of orders. Refer to FIGS. 3A-B for additional discussion.

The server can present, at the first user device, a second GUI display that includes indications of order hold locations and associated bags for the order (block 704). For example, the server can provide, to the first user device, information that, when processed by the first user device, causes the first user device to display the second GUI, the second GUI including indications of one or more order hold locations in the fulfillment location and one or more bags associated with each of the one or more order hold locations for the selected order to be delivered. Refer to FIG. 3C for additional discussion.

The server can receive, from the first user device, user input indicating selection of an indication of a bag to be put back in hold (block 706). For example, the server can receive, from the first user device, an indication of user selection of an indication of a bag presented in the second GUI indicating an intention to put the bag back in the respective hold location. The intention to put the bag back in the respective hold location can be based on the employee seeing the order in the first GUI presented in the first indicia, such as the yellow highlighting. Refer to FIG. 3C for additional discussion.

The server can present, at the first user device, a pop out window with information about the selected bag in block 708. For example, the server can provide, to the first user device, information that, when processed by the first device, causes the first device to display a pop out window that overlays a portion of the second GUI, the pop out window including information about items in the selected bag. Refer to FIG. 3D for additional discussion.

In block 710, the server can receive, from the first user device, user input indicating selection of an option to put the selected bag back to hold from the pop out window. As described herein, the pop out window can present various options based on use selection of a menu option in the pop out window. The options can include removing one or more items from hold, putting one or more of the items back to hold (e.g., returning the item(s) to the respective cold storage hold location(s)), and transferring the hold. Refer to FIG. 3D for additional discussion.

The server can also update, at the first user device, the indication of the selected bag in the second GUI displayed based on the user input in block 712. For example, the server can provide, to the first user device, information that, when processed by the first device, causes the first device to update the indication of the selected bag. Updating the indication of the selected bag can include changing the indication of the selected bag from a black bag icon to a green bag icon. Updating the indication of the selected bag can also include removing a hazard symbol overlaying a portion of the indication of the selected bag. One or more other updates can be made, as depicted and described throughout this disclosure.

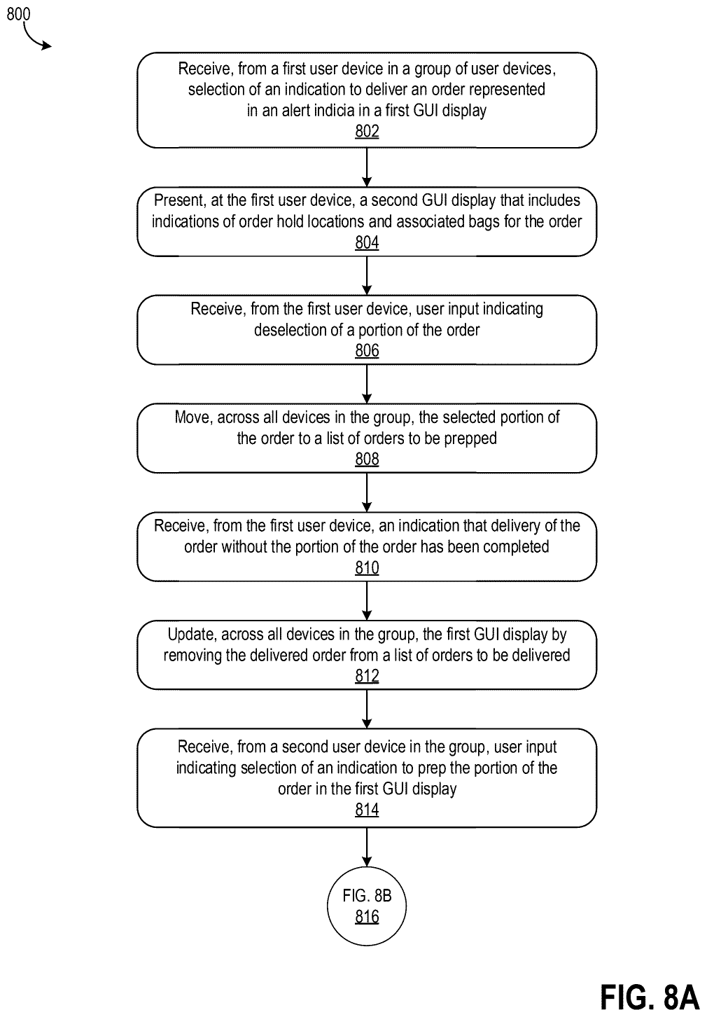

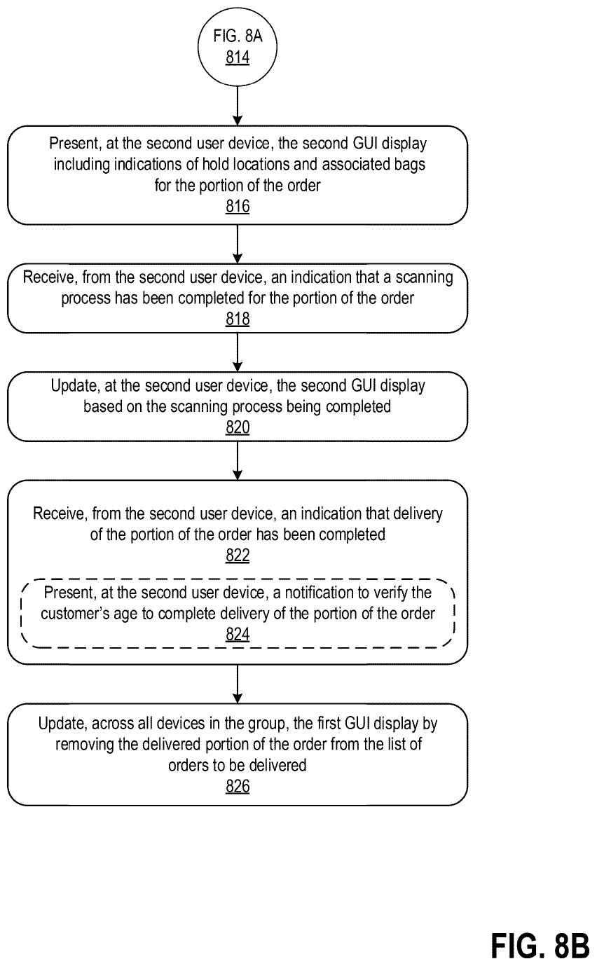

FIGS. 8A-B is a flowchart of a process 800 to be performed by one or more computing devices in a drive-up fulfillment system when an employee completes a partial order for a drive-up customer. The process 800 can be performed when the employee delivers only a portion of the order and a remainder of the order may be delivered at another time.

The process 800 can be performed by the server system 116 depicted and described in reference to FIG. 1. The process 800 can also be performed by any of the computing devices 118 of employees in the fulfillment location. The process 800 can also be performed by one or more other computing systems, devices, computers, networks, cloud-based systems, and/or cloud-based services. For illustrative purposes, the process 800 is described from the perspective of a server.

Referring to the process 800 in both FIGS. 8A-B, the server can receive, from a first user device in a group of user devices, selection of an indication to deliver (or prepare) an order represented in an alert indicia in a first GUI display (block 802). Refer to block 702 in the process 700 of FIG. 7 for additional discussion. In some implementations, the employee at the first user device can select the indication to deliver an order that is not represented in the alert indicia. In other words, the block 802 can be performed for any order for which an employee selects the indication to deliver the order. Refer to FIG. 4A for additional discussion.

In block 804, the server can present, at the first user device, a second GUI display that includes indications of order hold locations and associated bags for the order. Refer to block 704 in the process 700 of FIG. 7 for additional discussion. In some implementations, all the order hold locations for the order can be selected, as shown and described in FIG. 4B.

The server can receive, from the first user device, user input indicating deselection of a portion of the order in block 806. The indication of user deselection of an icon for a portion of the selected order to be delivered in the second GUI can indicate an intention to deliver the selected order without the portion of the order. As depicted and described in reference to FIG. 4C, the employee can deselect a checkbox next to the portion of the selected order that the employee does not wish to deliver. In some implementations, as described above, the employee can deselect the checkbox for a portion of the selected order that contains at least one age-restricted item (e.g., alcoholic beverage, adult beverage, tobacco products, other age-restricted items).

The server can move, across all devices in the group (or a subset of the user devices in the group), the selected portion of the order to a list of orders to be prepped or delivered (block 808). For example, as shown and described in FIG. 4D, the order containing the portions of the order that were default selected and not deselected by the employee can now be ready for prep and/or delivery. The deselected portion of the order containing the age-restricted item(s) may not be shown in the list of orders to be prepped or delivered.

The server can also receive, from the first user device, an indication that delivery of the order without the portion of the order has been completed (block 810). As described throughout this disclosure, the delivery can be completed based on the employee scanning the bags out of hold locations for the order that does not include the portion of the order that was deselected and then delivering those scanned bags to the customer. If the employee was the same employee who prepared the order, then the employee can simply bring the scanned bags to the customer's vehicle and confirm delivery. Refer to FIGS. 2A-Y and 4D for additional discussion about this process.

The server can update, across all devices in the group, the first GUI display by removing the delivered order from a list of orders to be delivered (block 812). Thus, the server can provide, to at least subset of the group of user devices, information that, when processed by each user device of the at least subset of the user devices, causes the user device to remove the delivered order from the list of orders in the first GUI.

The server can also receive, from a second user device in the group, user input indicating selection of an indication to prep the portion of the order in the first GUI display (block 814). For example, the server can receive, from the second user device of the group of user devices, an indication of user selection of a second control presented in the first GUI indicating an intention to prepare the portion of the order in the list of orders to be prepared. The second user device can be different from the first user device. In some implementations, the second user device can be the same as the first user device. Additionally, the portion of the order can include at least one of an adult or alcoholic beverage. The portion of the order can also include at least one medication or other pharmaceutical product. As described throughout this disclosure, the portion of the order can also include any other type of age-restricted item or item that requires verification of customer information/identity. Refer to FIG. 4E for additional discussion.

In block 816, the server can present, at the second user device, the second GUI display including indications of hold locations and associated bags for the portion of the order. Since the rest of the order has already been delivered, the hold locations and associated bags that have already been delivered may no longer be presented in the second GUI display. Therefore, the server can provide, to the second user device, information that, when processed by the second user device, causes the second user device to display the second GUI, the second GUI including indications of one or more order hold locations in the fulfillment location and one or more bags associated with each of the one or more order hold locations for the selected portion of the order to be prepared. Refer to FIG. 4F for additional discussion.

The server can receive, from the second user device, an indication that a scanning process has been completed for the portion of the order (block 818). For example, the server can receive, from the second user device, an indication that the one or more bags for the portion of the order have been scanned out of the one or more hold locations, as described throughout this disclosure. The server can then update, at the second user device, the second GUI display based on the scanning process being completed in block 820. Updating the second GUI display can including changing the indications of the bags from black bag icons to green bag icons, as described throughout this disclosure. Updating the second GUI display can also include making an option to complete delivery of the portion of the order selectable by the employee. Refer to FIG. 4G for additional discussion.

The server can also receive, from the second user device, an indication that delivery of the portion of the order has been completed in block 822. The delivery process can be similar or same as the delivery process described throughout this disclosure. Refer to FIGS. 2A-Y for additional discussion. Optionally, the server can present, at the second user device, a notification to verify the customer's age in order to complete delivery of the portion of the order (block 824). Refer to FIG. 4I for additional discussion. The notification can include one or more other checks to be performed by the employee in order to verify that the customer can pick up the portion of the order, as described in reference to FIG. 4I. Therefore, receiving, by the server and from the second user device, an indication that the portion of the order was delivered to the customer can include receiving an indication that customer information was verified, by the second user device, before delivering the portion of the order to the customer. The customer information can include at least one of a birthdate, a government ID, a drivers license, a passport, a medical prescription, and a pharmaceutical prescription. Moreover, verifying the customer information, by the second user device, can include determining that the customer information satisfies threshold requirements for delivering the portion of the order to the respective customer, the threshold requirements including at least one of (i) a minimum age for alcoholic consumption, (ii) a minimum age for alcoholic purchase, and (iii) a valid medical or pharmaceutical prescription.

The server can update, across all devices in the group of user devices, the first GUI display by removing the delivered portion of the order from the list of orders to be delivered (block 826). For example, the server can provide, to the at least subset of the group of user devices, information that, when processed by each user device, causes the user device to remove the portion of the order from the list of orders to be prepared and/or delivered in the first GUI.

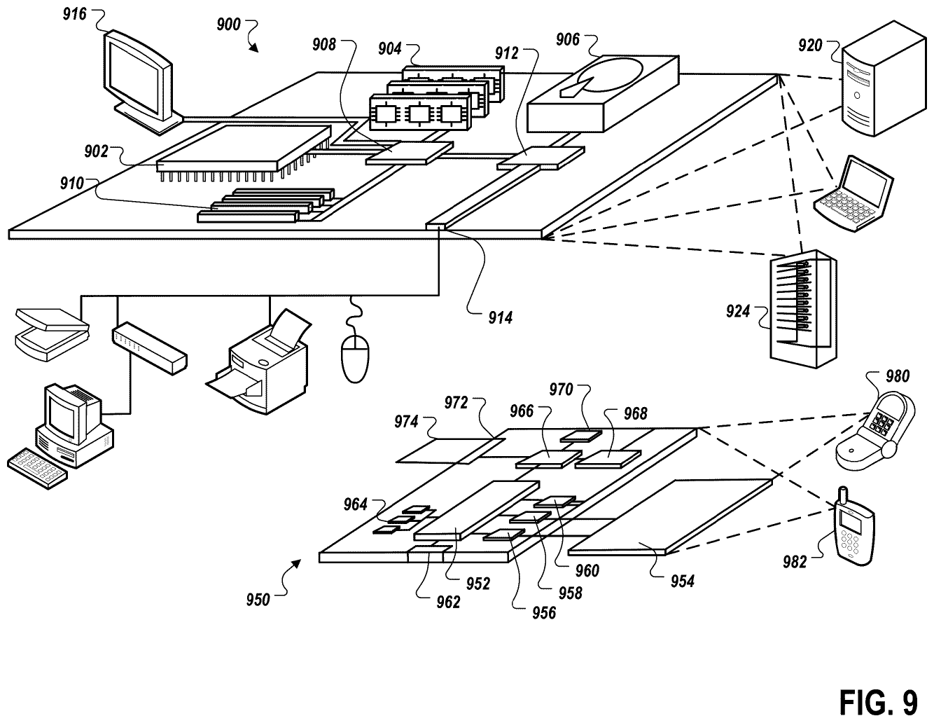

FIG. 9 shows an example of a computing device 900 and an example of a mobile computing device that can be used to implement the techniques described here. The computing device 900 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and can be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 can also be another form of computer-readable medium, such as a magnetic or optical disk.

The storage device 906 is capable of providing mass storage for the computing device 900. In some implementations, the storage device 906 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 904, the storage device 906, or memory on the processor 902.

The high-speed interface 908 manages bandwidth-intensive operations for the computing device 900, while the low-speed interface 912 manages lower bandwidth-intensive operations. Such allocation of functions is exemplary only. In some implementations, the high-speed interface 908 is coupled to the memory 904, the display 916 (e.g., through a graphics processor or accelerator), and to the high-speed expansion ports 910, which can accept various expansion cards (not shown). In the implementation, the low-speed interface 912 is coupled to the storage device 906 and the low-speed expansion port 914. The low-speed expansion port 914, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 900 can be implemented in a number of different forms, as shown in the figure. For example, it can be implemented as a standard server 920, or multiple times in a group of such servers. In addition, it can be implemented in a personal computer such as a laptop computer 922. It can also be implemented as part of a rack server system 924. Alternatively, components from the computing device 900 can be combined with other components in a mobile device (not shown), such as a mobile computing device 950. Each of such devices can contain one or more of the computing device 900 and the mobile computing device 950, and an entire system can be made up of multiple computing devices communicating with each other.

The mobile computing device 950 includes a processor 952, a memory 964, an input/output device such as a display 954, a communication interface 966, and a transceiver 968, among other components. The mobile computing device 950 can also be provided with a storage device, such as a micro-drive or other device, to provide additional storage. Each of the processor 952, the memory 964, the display 954, the communication interface 966, and the transceiver 968, are interconnected using various buses, and several of the components can be mounted on a common motherboard or in other manners as appropriate.

The processor 952 can execute instructions within the mobile computing device 950, including instructions stored in the memory 964. The processor 952 can be implemented as a chipset of chips that include separate and multiple analog and digital processors. The processor 952 can provide, for example, for coordination of the other components of the mobile computing device 950, such as control of user interfaces, applications run by the mobile computing device 950, and wireless communication by the mobile computing device 950.

The processor 952 can communicate with a user through a control interface 958 and a display interface 956 coupled to the display 954. The display 954 can be, for example, a TFT (Thin-Film-Transistor Liquid Crystal Display) display or an OLED (Organic Light Emitting Diode) display, or other appropriate display technology. The display interface 956 can comprise appropriate circuitry for driving the display 954 to present graphical and other information to a user. The control interface 958 can receive commands from a user and convert them for submission to the processor 952. In addition, an external interface 962 can provide communication with the processor 952, so as to enable near area communication of the mobile computing device 950 with other devices. The external interface 962 can provide, for example, for wired communication in some implementations, or for wireless communication in other implementations, and multiple interfaces can also be used.

The memory 964 stores information within the mobile computing device 950. The memory 964 can be implemented as one or more of a computer-readable medium or media, a volatile memory unit or units, or a non-volatile memory unit or units. An expansion memory 974 can also be provided and connected to the mobile computing device 950 through an expansion interface 972, which can include, for example, a SIMM (Single In Line Memory Module) card interface. The expansion memory 974 can provide extra storage space for the mobile computing device 950, or can also store applications or other information for the mobile computing device 950. Specifically, the expansion memory 974 can include instructions to carry out or supplement the processes described above, and can include secure information also. Thus, for example, the expansion memory 974 can be provide as a security module for the mobile computing device 950, and can be programmed with instructions that permit secure use of the mobile computing device 950. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 964, the expansion memory 974, or memory on the processor 952. In some implementations, the computer program product can be received in a propagated signal, for example, over the transceiver 968 or the external interface 962.

The mobile computing device 950 can communicate wirelessly through the communication interface 966, which can include digital signal processing circuitry where necessary. The communication interface 966 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 968 using a radio-frequency. In addition, short-range communication can occur, such as using a Bluetooth, WiFi, or other such transceiver (not shown). In addition, a GPS (Global Positioning System) receiver module 970 can provide additional navigation- and location-related wireless data to the mobile computing device 950, which can be used as appropriate by applications running on the mobile computing device 950.

The mobile computing device 950 can also communicate audibly using an audio codec 960, which can receive spoken information from a user and convert it to usable digital information. The audio codec 960 can likewise generate audible sound for a user, such as through a speaker, e.g., in a handset of the mobile computing device 950. Such sound can include sound from voice telephone calls, can include recorded sound (e.g., voice messages, music files, etc.) and can also include sound generated by applications operating on the mobile computing device 950.

The mobile computing device 950 can be implemented in a number of different forms, as shown in the figure. For example, it can be implemented as a cellular telephone 980. It can also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A method comprising:
providing, by a computing system to each of a plurality of user devices, information that, when processed by each of the plurality of user devices, causes each of the plurality of user devices to display a first graphical user interface (GUI), the first GUI including a list of orders for customers for fulfillment at a fulfillment location;
determining, by the computing system and for each order in the list of orders, an amount of time that the order has been scanned out of a hold location and awaiting customer arrival;
determining, by the computing system and for each order in the list of orders, whether the amount of time exceeds a first threshold amount of time; and
providing, by the computing system to at least a subset of the plurality of user devices and based on a determination that the amount of time for the order exceeds the first threshold amount of time, instructions to update the first GUI such that the order is represented in a first indicia.

2. The method of claim 1, wherein the first indicia is yellow highlighting.

3. The method of claim 1, wherein the first threshold amount of time is 10 minutes.

4. The method of claim 1, further comprising:
determining, by the computing system and for each order in the list of orders, whether the order has been returned to the hold location within a second threshold amount of time from being scanned out of the hold location; and
providing, by the computing system to at least a subset of the plurality of user devices and based on a determination that the order has not been returned within the second threshold amount of time, instructions to update the first GUI such that the order is represented in a second indicia, the second indicia being different from the first indicia.

5. The method of claim 4, wherein the second threshold amount of time is 15 minutes.

6. The method of claim 1, further comprising: providing, by the computing system to each of the plurality of user devices, information that, when processed by each of the plurality of user devices, causes each of the plurality of user devices to display at least one graphical icon with each order in the list of orders in the first GUI display, wherein the at least one graphical icon provides a visual indication of a type of item associated with the order.

7. The method of claim 6, wherein the at least one graphical icon includes a visual depiction of one or more alcoholic beverages.

8. The method of claim 1, further comprising:
receiving, by the computing system and from a first user device of the plurality of user devices, an indication of user selection of a first control presented in the first GUI indicating an intention to deliver an order in the list of orders;
providing, by the computing system at the first user device, information that, when processed by the first user device, causes the first user device to display a second GUI, the second GUI including indications of one or more order hold locations in the fulfillment location and one or more bags associated with each of the one or more order hold locations for the selected order to be delivered;
receiving, by the computing system and from the first user device, an indication of user selection of an indication of a bag presented in the second GUI indicating an intention to put the bag back in the respective hold location;
providing, by the computing system to the first user device, information that, when processed by the first device, causes the first device to display a pop out window that overlays a portion of the second GUI, the pop out window including information about items in the selected bag;
receiving, by the computing system and from the first user device, an indication of user selection of an option presented in the pop out window to put the selected bag back in the respective hold location; and
providing, by the computing system to the first user device, information that, when processed by the first device, causes the first device to update the indication of the selected bag.

9. The method of claim 8, wherein updating the indication of the selected bag includes changing the indication of the selected bag from a black bag icon to a green bag icon.

10. The method of claim 8, wherein updating the indication of the selected bag includes removing a hazard symbol overlaying a portion of the indication of the selected bag.

11. The method of claim 8, further comprising:
receiving, by the computing system and from the first user device, an indication of user deselection of an icon for a portion of the selected order to be delivered in the second GUI indicating an intention to deliver the selected order without the portion of the order; and
providing, by the computing system and to at least a subset of the plurality of user devices, information that, when processed by each user device of the at least subset of the plurality of user devices, causes the user device to present the portion of the selected order in a list of orders to be prepared in the first GUI.

12. The method of claim 11, further comprising:
receiving, by the computing system and from the first user device, an indication that the selected order was delivered to a respective customer without the portion of the order; and
providing, by the computing system and to the at least subset of the plurality of user devices, information that, when processed by each user device of the at least subset of the plurality of user devices, causes the user device to remove the delivered order from the list of orders in the first GUI.

13. The method of claim 11, further comprising:
receiving, by the computing system and from a second user device of the plurality of user devices, an indication of user selection of a second control presented in the first GUI indicating an intention to prepare the portion of the order in the list of orders to be prepared;
providing, by the computing system at the second user device, information that, when processed by the second user device, causes the second user device to display the second GUI, the second GUI including indications of one or more order hold locations in the fulfillment location and one or more bags associated with each of the one or more order hold locations for the selected portion of the order to be prepared;
receiving, by the computing system from the second user device, an indication that the one or more bags for the portion of the order have been scanned out of the one or more hold locations;
receiving, by the computing system from the second user device, an indication that the portion of the order was delivered to a respective customer; and
providing, by the computing system and to the at least subset of the plurality of user devices, information that, when processed by each user device of the at least subset of the plurality of user devices, causes the user device to remove the portion of the order from the list of orders to be prepared in the first GUI.

14. A method for managing and delivering orders having special items to customers at an order fulfillment location, the method comprising:
receiving, from a computing system and at a user device in a plurality of user devices, information that, when processed by the user device, causes the user device to display a first graphical user interface (GUI) including a list of orders for customers for fulfillment at a fulfillment location;
presenting, at the user device and for each order in the list of orders, an amount of time that the order has been scanned out of a hold location and awaiting customer arrival;
receiving, from the computing system and at the user device, instructions to update the first GUI based on a determination, by the computing system and for each order in the list of orders, that the amount of time for the order exceeds a first threshold amount of time; and
presenting, at the user device and based on the instructions from the computing system, the order in the list of orders in a first indicia.

15. The method of claim 14, wherein the order includes at least one special item, the special item being at least one of a refrigerated item and a frozen item.

16. The method of claim 14, further comprising:
receiving, at the user device, an indication of user selection of a first control presented in the first GUI indicating an intention to deliver an order in the list of orders;
receiving, from the computing system at the user device, information that, when processed by the user device, causes the user device to display a second GUI including indications of one or more order hold locations in the fulfillment location and one or more bags associated with each of the one or more order hold locations for the selected order to be delivered;
receiving, at the user device, an indication of user selection of an indication of a bag presented in the second GUI indicating an intention to put the bag back in the respective hold location, wherein the bag includes at least one special item;
receiving, from the computing system at the user device, information that, when processed by the user device, causes the user device to display a pop out window that overlays a portion of the second GUI, the pop out window including information about items in the selected bag;
receiving, at the user device, an indication of user selection of an option presented in the pop out window to put the selected bag back in the respective hold location; and
receiving, from the computing system at the user device, information that, when processed by the user device, causes the user device to update the indication of the selected bag.

17. The method of claim 16, wherein the at least one special item is at least one of a grocery item, a refrigerated item, a frozen item, an adult beverage, a tobacco product, and a medication.

18. The method of claim 16, wherein the intention to put the bag back in the respective hold location is based at least in part on the order being presented in the first GUI in the first indicia.

19. The method of claim 16, wherein the intention to put the bag back in the respective hold location is based at least in part on the bag containing an age-restricted item.

20. A system comprising:
one or more processors; and
computer memory containing instructions that, when executed by the one or more processors, cause the system to perform operations comprising:
providing, to each of a plurality of user devices, information that, when processed by each of the plurality of user devices, causes each of the plurality of user devices to display a first graphical user interface (GUI), the first GUI including a list of orders for customers for fulfillment at a fulfillment location;
determining, for each order in the list of orders, an amount of time that the order has been scanned out of a hold location and awaiting customer arrival;
determining, for each order in the list of orders, whether the amount of time exceeds a first threshold amount of time; and
providing, to at least a subset of the plurality of user devices and based on a determination that the amount of time for the order exceeds the first threshold amount of time, instructions to update the first GUI such that the order is represented in a first indicia.
